(19) United States
(12) Patent Application Publication
(10) Pub. No.: US 2006/0195335 A1
(43) Pub. Date: Aug. 31, 2006

(54) System and method for career development

(76) Inventors: Lana Starr Christian, Carmel, IN (US); Jennifer Joan Olson, Indianapolis, IN (US); Linda Lee Kozimor, Indianapolis, IN (US); Anthony Philip Carr, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/336,260

(22) Filed: Jan. 20, 2006

Related U.S. Application Data
(60) Provisional application No. 60/645,852, filed on Jan. 21, 2005.

(51) Int. Cl. G06Q 99/00; G06F 11/34; H04K 1/00; H04M 3/51; H04L 9/00

(52) U.S. Cl. 705/1; 705/80; 705/11

(57) ABSTRACT

A computer system and method is disclosed that aids in career development. Several client workstations and servers are coupled together over a communications network. A web server provides access to a career development web site to client computers. The web server provides various career development modules, such as an information module, orientation module, exploration module, preparation module, destination module, and/or success strategies module. A database server stores information related to the operation of the web site. At least one client computer is used for allowing one or more field guides and/or administrators to administer the site. At least one client computer contains a browser user interface to allow end users to interact with the web site.

### CROSS-REFERENCE TO RELATED APPLICATIONS

This application claims the benefit of U.S. Provisional Patent Application No. 60/645,852 filed Jan. 21, 2005.

### BACKGROUND

Various tools are offered by employers to employees to provide career development assistance. Some companies offer online portals that allow employees to view job postings, view career development tips, and so on. Other companies offer employee handbooks which provide tips to employees on advancing within the organization. Some companies even offer career counselors who will work one-on-one with employees to help them reach their goals. Yet other companies offer career advancement workshops to expand upon written handbooks with additional materials. Each of these approaches focuses on one or more particular aspects of the career development process, but do not really offer an organized and/or comprehensive set of resources to guide and motivate the employee throughout the entire process. Further advancements are needed to improve the career development process.

### SUMMARY

One form of the present invention is a unique system for providing career development.

Yet another form includes unique systems and methods to provide career development using on-line techniques.

A web server provides access to a career development web site to client computers. The web server provides various features that guide the end user, such as an employee, through the career development process. The web site offers several career development modules, such as an information module, orientation module, exploration module, preparation module, destination module, and/or success strategies module. A database server stores information related to the operation of the web site. At least one client computer is used for allowing one or more field guides and/or administrators to administer various features of the site. At least one client computer contains a browser user interface to allow end users to interact with the web site.

Another form includes a computer system and method for assisting users with career development. The user can test basic computer skills and/or review a list of helpful computer classes before signing up for an account to access the career development site. The user obtains a network ID to access the career development site, as well as an email address to be used for communication during the development process. The user then learns an overview about the career development system and the resources offered. At this point, the user decides to register or opt out of the program. Upon completing the introductory module and registration process, the user meets with a field guide to review progress, complete a checklist, and receive a reward related to or useful in their career. The user then learns details about the career development system and how it operates. Upon completing this orientation module, the user meets with the field guide to review progress, complete a checklist, and receive another reward related to or useful in their career. Based on the assessment scores, the user is placed in the exploration of preparation module. If moving to the exploration module, the user explores career options. After completing the exploration module, the user again meets with the field guide to review progress, complete a checklist, and obtain a reward. If placed in the preparation module, the user works on their basic skills until a minimum level is obtained. If part of the normal process, the user finalizes the details for reaching their career goals. After completion of this module, the user has another progress meeting with the field guide to discuss their progress, complete a checklist, and obtain a reward. Once the goal is reached, the user completes a destination module and has a final meeting with the field guide to discuss successful completion and to receive a final reward. There is also an optional success strategies module that the user can review at any time during this process.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a logical diagram illustrating some of the features provided by the system of FIG. 1.

FIG. 3A is a first portion of a high level process flow diagram for the system of FIG. 1 demonstrating the stages involved in the career development process.

FIG. 3B is a second portion of a high level process flow diagram for the system of FIG. 1 demonstrating the stages involved in the career development process.

FIG. 4 is a process flow diagram for the system of FIG. 1 illustrating the stages involved in the information module.

FIG. 5 is a process flow diagram for the system of FIG. 1 demonstrating the stages involved in the orientation module.

FIG. 6 is a process flow diagram for the system of FIG. 1 illustrating the stages involved in the exploration module.

FIG. 7 is a process flow diagram for the system of FIG. 1 illustrating the stages involved in the preparation module.

FIG. 8 is a process flow diagram for the system of FIG. 1 illustrating the stages involved in the destination module.

FIG. 9 is a process flow diagram for the system of FIG. 1 illustrating the stages involved in the success strategies module.

FIG. 10 is a process flow diagram for the system of FIG. 1 illustrating the stages involved in allowing a field guide to administer the site.

FIG. 11 is a process flow diagram for the system of FIG. 1 illustrating the stages involved in allowing an administrator to administer the site.

FIG. 12 is a simulated browser user interface screen illustrating an introduction screen to the career development system of FIG. 1.

FIG. 13 is a simulated browser user interface screen illustrating a basic computer skills testing screen of the system of FIG. 1.

FIGS. 14-16 are simulated browser user interface screens illustrating a sample of the information offered in the information module of the system of FIG. 1 and in accordance with the stages of FIG. 4.

FIGS. 17-21 are simulated browser user interface screens illustrating a sample of the information offered in the orientation module of the system of FIG. 1 and in accordance with the stages of FIG. 5.

FIGS. 22-27 are simulated browser user interface screens illustrating a sample of the information offered in the exploration module of the system of FIG. 1 and in accordance with the stages of FIG. 6.

FIGS. 28-37 are simulated browser user interface screens illustrating a sample of the information offered in the preparation module of the system of FIG. 1 and in accordance with the stages of FIG. 7.

FIG. 38 is a simulated browser user interface screen illustrating a sample of the information offered in the destination module of the system of FIG. 1 and in accordance with the stages of FIG. 8.

FIGS. 39-41 are simulated browser user interface screens illustrating a sample of the information offered in the success strategies module of the system of FIG. 1 and in accordance with the stages of FIG. 9.

FIGS. 42-43 are simulated browser user interface screens illustrating a sample of the features available to field guides with the system of FIG. 1 and in accordance with the stages of FIG. 10.

FIGS. 44-46 are simulated browser user interface screens illustrating a sample of the features available to administrators with the system of FIG. 1 and in accordance with the stages of FIG. 11.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

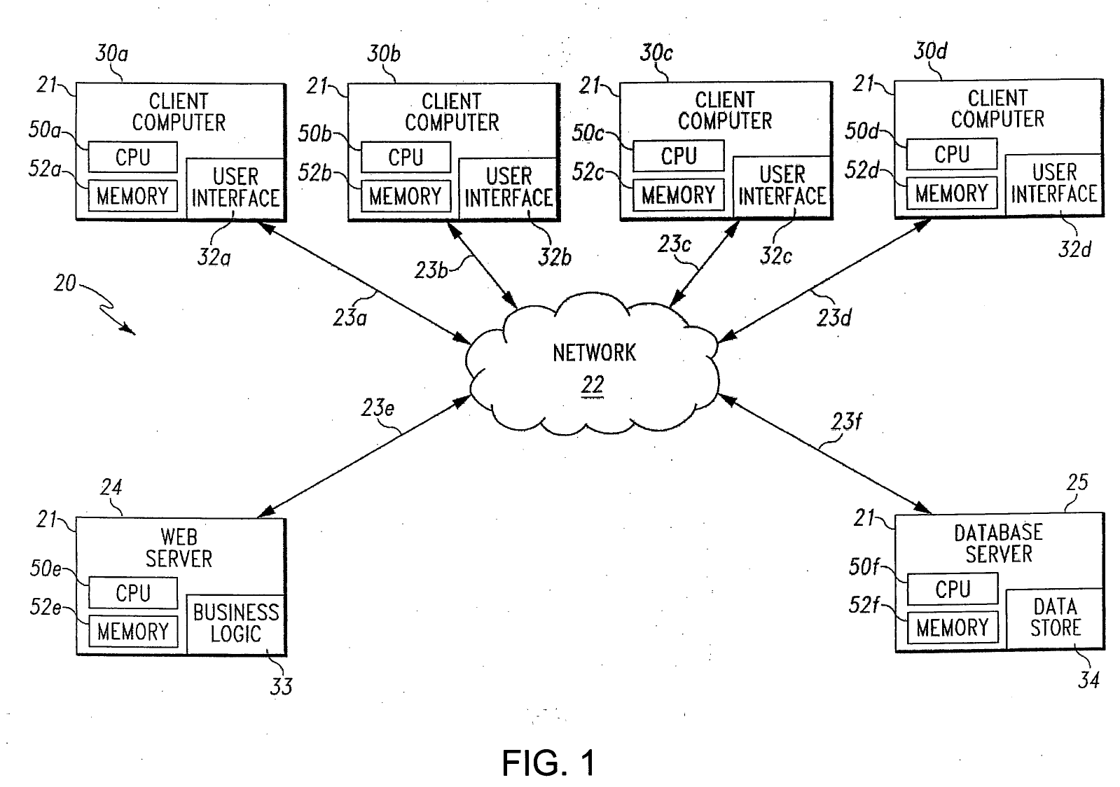

One embodiment of the present invention includes a unique system for providing career development. FIG. 1 is a diagrammatic view of computer system 20 of one embodiment of the present invention. Computer system 20 includes computer network 22. Computer network 22 couples together a number of computers 21 over network pathways 23a-f. More specifically, system 20 includes several servers, namely Web Server 24 and Database Server 25. System 20 also includes client workstations 30a, 30b, 30c, and 30d (collectively workstations 30). While computers 21 are each illustrated as being a server or client, it should be understood that any of computers 21 may be arranged to include both a client and server. Furthermore, it should be understood that while six computers are illustrated, more or fewer may be utilized in alternative embodiments.

Computers 21 include one or more processors or CPUs (50a, 50b, 50c, 50d, 50e, and 50f, respectively) and one or more types of memory (52a, 52b, 52c, 52d, 52e, and 52f, respectively). Each memory 52a, 52b, 52c, 52d, 52e, and 52f may include a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, U.S.A.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display. Computers may be of the same type, or a heterogeneous combination of different computing devices. Likewise, displays may be of the same type, or a heterogeneous combination of different visual devices. Although again not shown to preserve clarity, each computer may also include one or more operator input devices such as a keyboard, mouse, track ball, light pen, and/or microtelecommunicator, to name just a few representative examples. Also, besides a display, one or more other output devices may be included such as loudspeaker(s) and/or a printer. Various display and input device arrangements are possible.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where Web Server 24 is configured as a web server that hosts application business logic 33, Database Server 25 is configured as a database server for storing relational and other data 35, and client workstations 30a-30d are configured for providing a browser-based user interface 32a-32d, respectively. In one embodiment, at least one of browser-based user interfaces 32a-32d is used for end users to interact with a career development web site, at least one is used for allowing a field guide to administer the site, and at least one is used for allowing an administrator to administer the site. Typical applications of system 20 would include more or fewer client workstations of this type at one or more physical locations, but four have been illustrated in FIG. 1 to preserve clarity. Furthermore, although two servers are shown, it will be appreciated by those of ordinary skill in the art that the one or more features provided by Web Server 24 and Database Server 25 could be provided on the same computer or varying other arrangements of computers at one or more physical locations and still be within the spirit of the invention. Farms of dedicated servers could also be provided to support the specific features if desired.

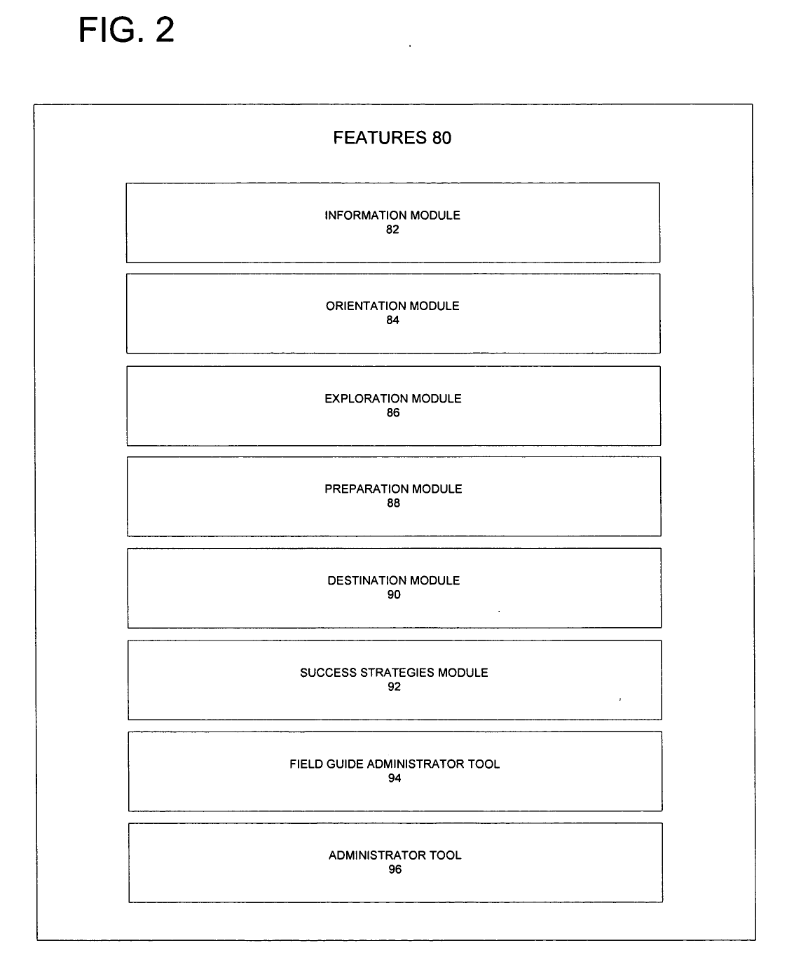

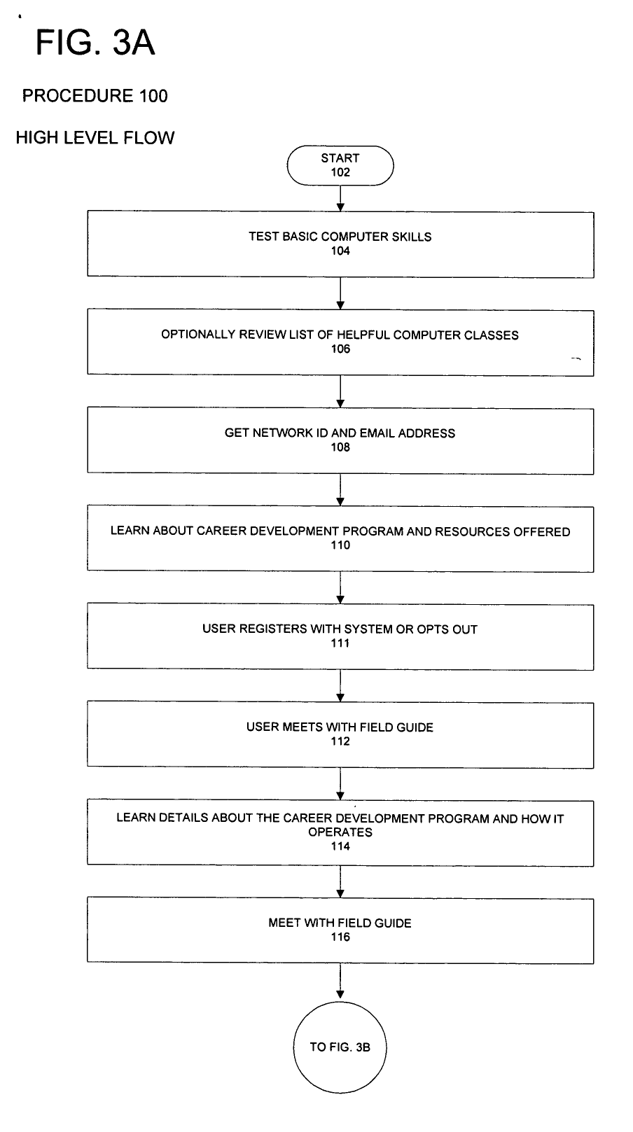

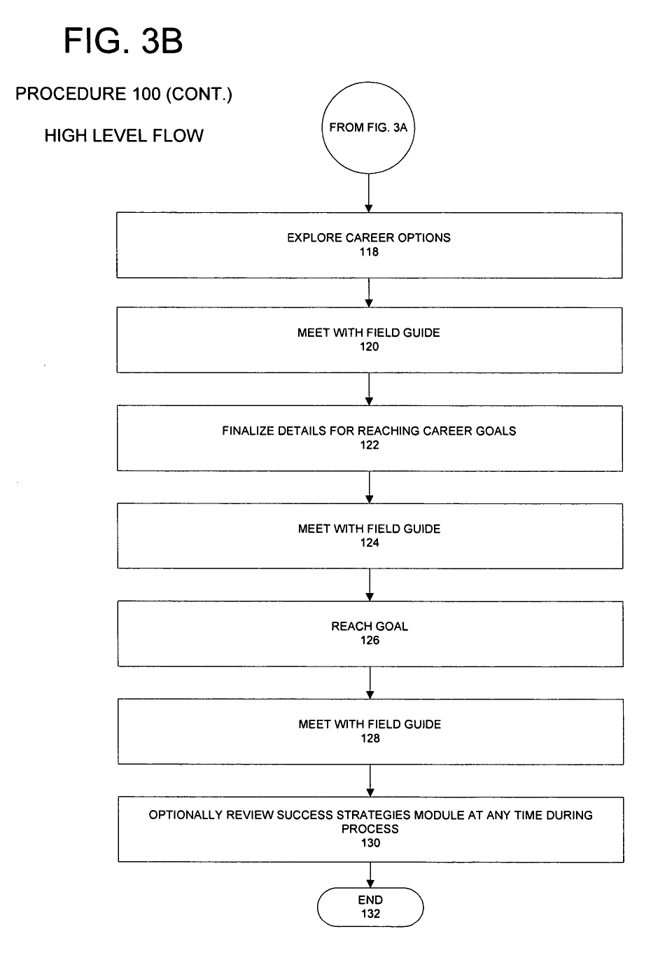

FIG. 2 is a logical diagram illustrating features 80 that are provided by the system of FIG. 1. Web server 24 of system 20 can provide to client workstations 30 some or all of the following features: information module 82, orientation module 84, exploration module 86, preparation module 88, destination module 90, success strategies module 92, field guide administrative tool 94, and administrator tool 96. Additional features can also be offered. These modules help guide the user through the employee development process, and the administrative tools help counselors, hereinafter “field guides”, and administrators manage the site. Each of these features will now be described in greater detail in FIGS. 3-11.

Turning now to FIG. 3, one embodiment for implementing system 20 is illustrated in flow chart form as procedure 100, which demonstrates the high level stages involved in the career development process. In one form, procedure 100 is at least partially implemented in the operating logic of system 20. Procedure 100 begins at start point 102 with a user selecting an option to test basic computer skills (stage 104). If the user is an advanced computer user already, he can choose to skip this option. After testing basic computer skills, the user can optionally review a list of helpful computer classes to take for additional training (stage 106). The user then obtains a network ID to access the career development system, as well as an email account to be used throughout the process (stage 108). The user can then access the information module to learn an overview about the career development system and the resources it offers (stage 110). At this point, the user registers in the system or opts out (stage 111). After completing the information module and choosing to continue, the user meets with an assigned field guide to review progress and obtain a reward related to or useful in their career advancement process (stage 112). The user then works through the orientation module to learn details about the career development system and how it operates (stage 114). The user again meets with their assigned field guide to discuss their progress, complete a checklist, and obtain another reward (stage 116). Depending on the assessment scores, the user is directed to either the exploration module in the traditional route, or to the preparation module in the remedial route.

After meeting with their field guide, the user works through the exploration module to explore various career options (stage 118). Upon completing the exploration module, the user meets with the field guide again to review their progress, complete a checklist, discuss some prospective careers, and receive another reward (stage 120). The user then progresses to the preparation module, where he learns how to finalize the details for reaching his career goals (stage 122). After finishing the preparation module, the user has another progress meeting with the field guide to review their progress and obtain yet another reward (stage 124). Upon reaching the goal, the user completes the destination module (stage 126) and has a wrap-up meeting with their assigned field guide (stage 128). The user can optionally review the success strategies module at any time during the process to address work/life issues (stage 130). The user is provided with checklists at various stages throughout the process, such as to ensure the objectives were met before scheduling a meeting with the field guide. The field guide may also have a complimentary checklist to ensure the user is prepared to move on to the next module. The user is also provided with an on-line guide that is displayed on a portion of the screen to offer helpful tips periodically. Alternatively or additionally, an inspirational quote and/or definition of a new term is also displayed on occasion. The process then ends at stage 132.

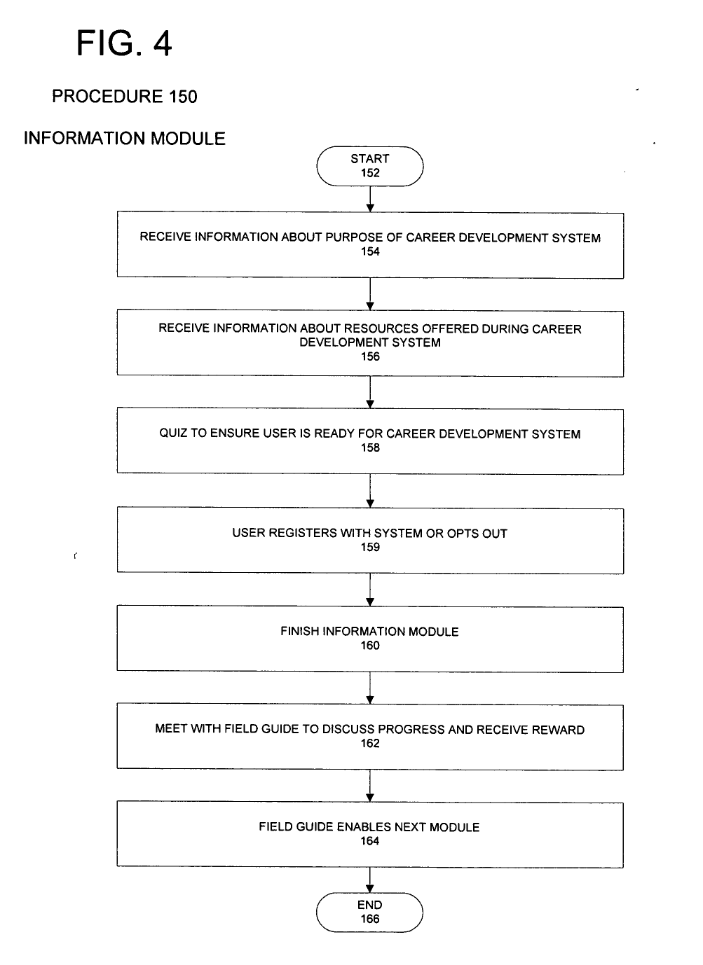

Turning now to FIG. 4, one embodiment for implementing system 20 with information module 82 is illustrated in flow chart form as procedure 150, which demonstrates the stages and features involved in the information module. In one form, procedure 150 is at least partially implemented in the operating logic of system 20. Procedure 150 begins at start point 152 with the system displaying and the user receiving information about the purpose of the career development system (stage 154). The user is guided through a series of screens that provide information about the resources offered during the career development system (stage 156). The user is also prompted to take a quiz to ensure he or she is ready to use the career development system and is committed to doing what is required in order to be successful (stage 158). At this point, the user may be required to either register with the system or opt out of the program (stage 159).

Upon completing the information module (stage 160), the user then meets with a field guide (stage 162). During the meeting the field guide uses her checklist to establish a dialog with the user. After this meeting, the field guide provides to the user a reward recognizing their progress that is related to or useful in a career. By way of non-limiting example, the user can be provided with a reward such as a pocket calendar for tracking appointments and class dates, a passport to be stamped upon completion of a class, assessment, or other activity, a pin to be worn by user to recognize their accomplishments, or a notebook in which the user may keep notes and other career development activities organized. In addition to providing the user with a reward, the field guide enables the orientation module for the user so the user is able to advance to the next step (stage 164). The process ends at stage 166.

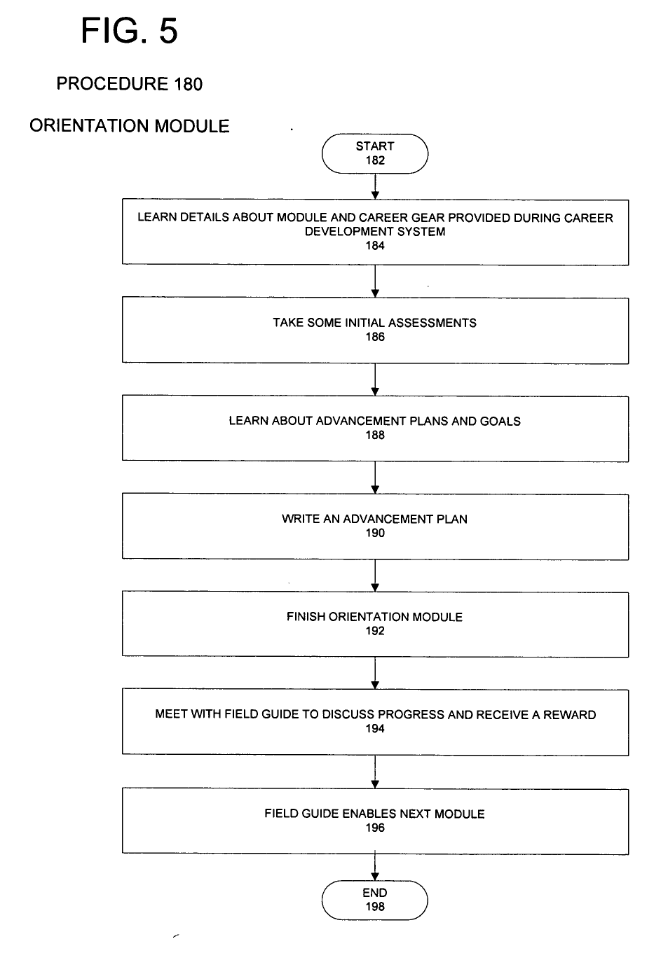

Turning now to FIG. 5, one embodiment for implementing system 20 with orientation module 84 is illustrated in flow chart form as procedure 180, which demonstrates the stages and features involved in the orientation module. In one form, procedure 180 is at least partially implemented in the operating logic of system 20. Procedure 180 begins at start point 182 with the system providing and the user learning details about the module and the rewards provided during the career development process (stage 184). The user is then guided through various other orientation topics, including taking some initial assessments (stage 186), learning about advancement plans and goals (stage 188), and writing an advancement plan (stage 190). By way of non-limiting example, the advancement plan may be a checklist of goals to help the employee map out the steps required to achieve a selected new career.

Upon completion of orientation module (stage 192), the user again meets with the field guide (stage 194). When meeting with the field guide, the user's progress is reviewed, a checklist is completed, and if the field guide determines that the user has successfully completed the orientation module, then the field guide provides the user with another reward in recognition of their progress that is related to or useful in a career. Upon successful completion of the orientation module, the user can receive a reward such as an insulated lunch cooler for pack-and-go meals, to name one non-limiting example. The field guide enables the exploration or preparation module for the user so the user is able to access the next step (stage 196). The process ends at stage 198.

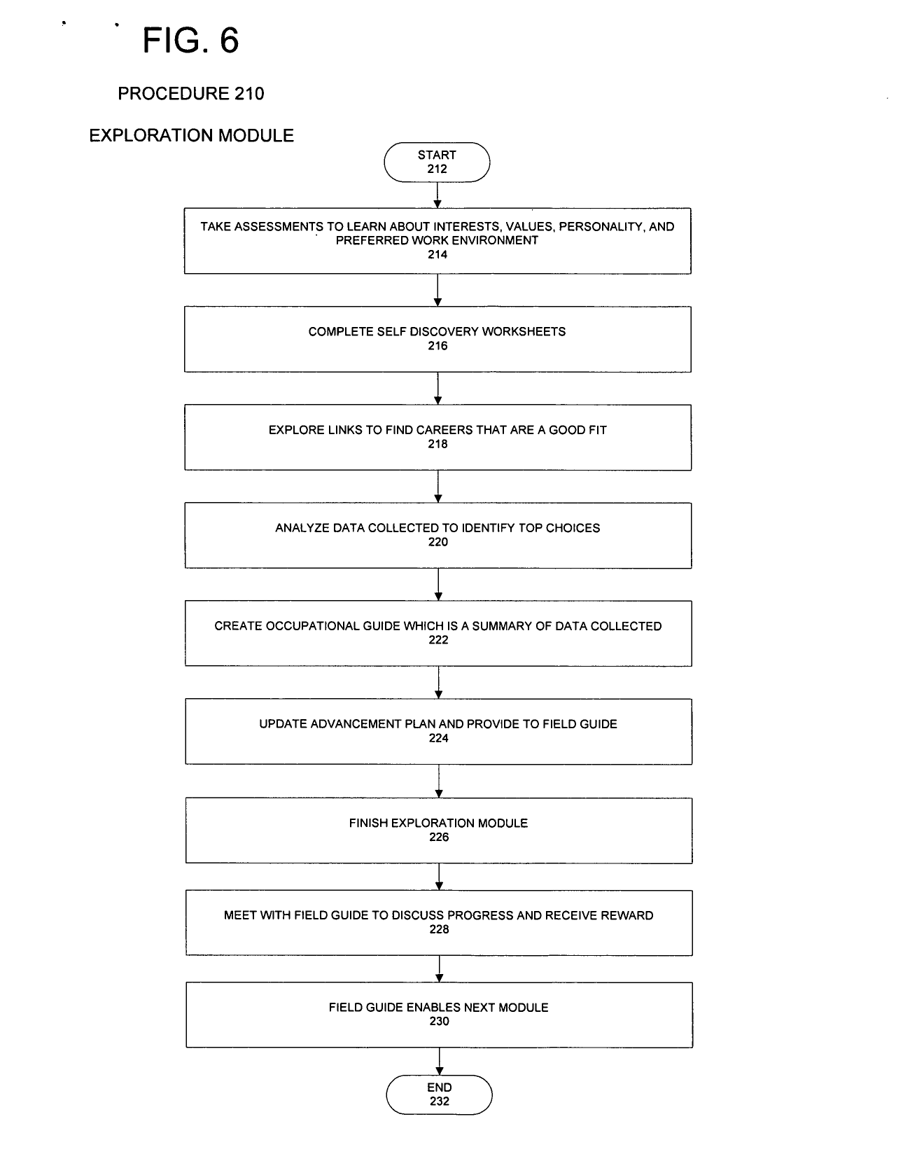

Turning now to FIG. 6, one embodiment for implementing system 20 with exploration module 86 is illustrated in flow chart form as procedure 210, which demonstrates the stages and features involved in the exploration module. In one form, procedure 210 is at least partially implemented in the operating logic of system 20. Procedure 210 begins at start point 212 with the user taking various assessments to learn about his interests, values, personality, and preferred work environment (stage 214). The user is also prompted to complete self discovery worksheets (stage 216). The user is provided with various links to resources that help locate careers that might be a good fit based upon the identified information (stage 218). After taking the assessments, completing the worksheets, and doing research, the user is then prompted to analyze the data collected to identify their top career choices (stage 220). The user is then guided through the process of creating an occupational guide that summarizes the data collected (stage 222). The user is also prompted to update their advancement plan in order to include the requirements necessary for moving into their new career and provide it to their field guide (stage 224) by email or in person.

Upon completing the work in the exploration module (stage 226), the user meets with the field guide to discuss his progress and complete the checklist (stage 228). If the field guide is satisfied with the user's completion of the exploration module, then the user may be provided with a reward, by way of non-limiting example, such as a backpack or shoulder bag in which to carry their career development materials. The field guide also enables the preparation module so the user is now able to access the next step (stage 230). The process then ends at stage 232.

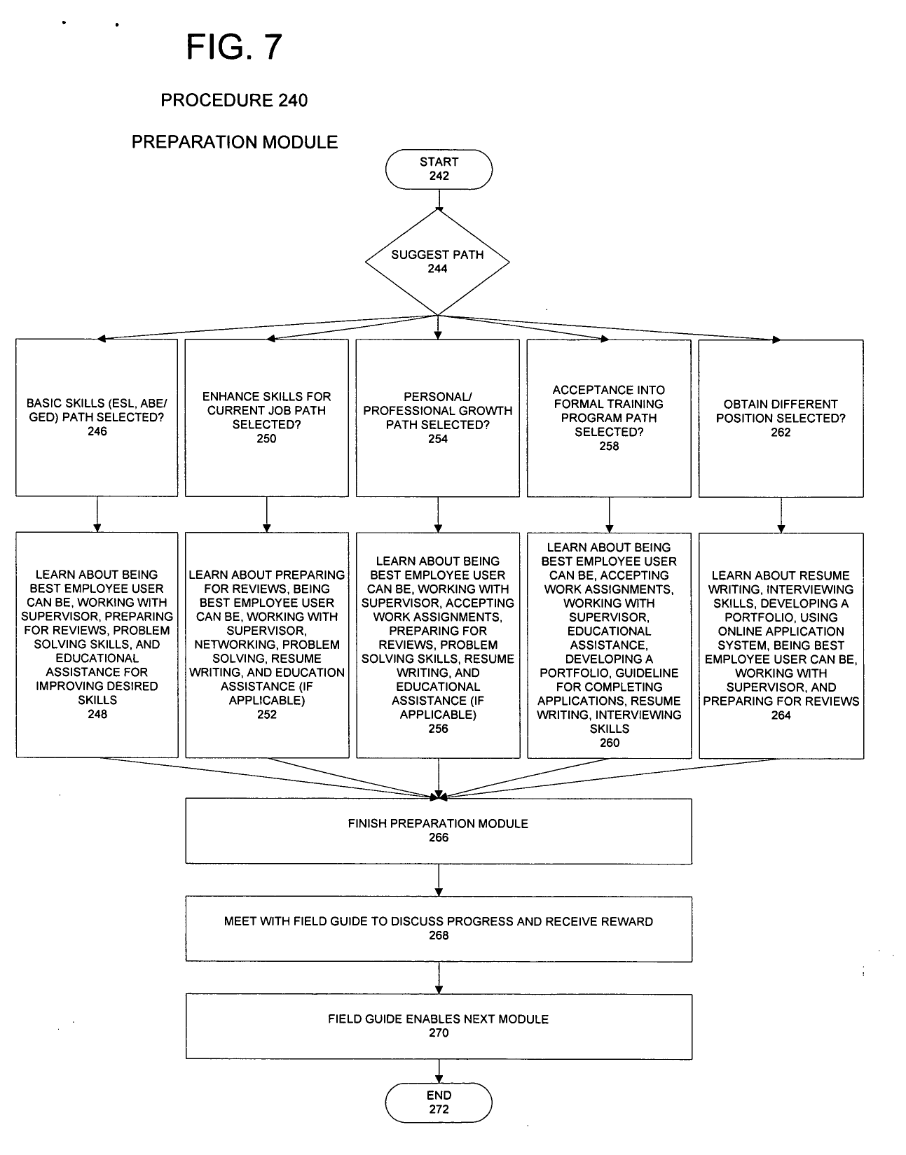

Turning now to FIG. 7, one embodiment for implementing system 20 with preparation module 88 is illustrated in flow chart form as procedure 240, which demonstrates the stages and features involved in the preparation module. In one form, procedure 240 is at least partially implemented in the operating logic of system 20. Procedure 240 begins at start point 242 with the user selecting a suggested path to pursue based upon their career advancement goals. In one embodiment, the options for career advancement include improving basic skills, enhancing skills for a current job, personal growth, acceptance into a formal training program, and/or pursuing a different job. When any of these educational paths are suggested (decision stage 244), general topics such as learning how to be the best employee, working with a supervisor, accepting work assignments, preparing for performance reviews, and/or problem solving skills are covered, as a few non-limiting examples.

If the user is directed to the basic skills (ESL, ABE/GED) path (decision point 246), then the user is provided with educational assistance information for skills he desires to gain or improve, in addition to the general topics covered in all paths (stage 248). If the user selects the path for enhancing skills for the current job (decision point 250), then the user is provided with information regarding networking, problem solving, resume writing, and/or educational assistance (if applicable), in addition to the general topics (stage 252).

If the path for personal/professional growth is selected (decision point 254), then in addition to the general topics covered in all paths, the user is provided with information to assist with enrichment inside and outside the workplace, such as educational assistance (if applicable) (stage 256). Examples of educational assistance include providing information regarding internal company resources, community-based classes, community resources such as the YMCA, high school and/or vocational school courses, and/or how to find additional educational assistance using search engines. If the path for acceptance into a formal training program is selected (decision point 258), then the user is provided with information such as educational assistance, developing her portfolio, guidelines for completing the appropriate applications, resume writing, and/or interviewing skills, in addition to the general topics (stage 260). If the path for obtaining a different position is selected (decision point 262), then in addition to the general topics covered in all paths, the user is provided with information such as resume writing, interviewing skills, developing her portfolio, and/or using the online application system (stage 264).

Upon completing the preparation module (stage 266), the user again meets with the field guide to discuss her progress and complete a checklist (stage 268). If the field guide is satisfied with the user's progress, then the field guide provides the user with a reward that is related to a career. A non-limiting example of such a reward provided upon completion of the preparation module includes a portfolio in which the user can keep his resume and other related papers for subsequent job interviews. The field guide also enables the destination module for the user so that the user can continue in their selected path (stage 270). The process then ends at stage 272.

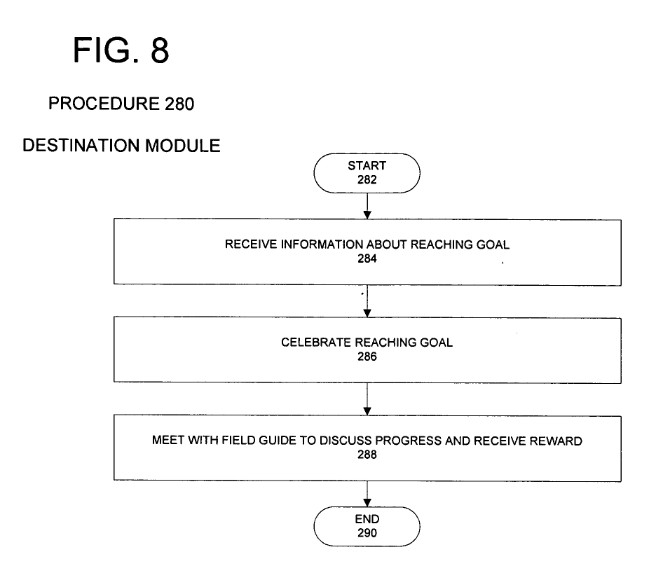

Turning now to FIG. 8, one embodiment for implementing system 20 with destination module 90 is illustrated in flow chart form as procedure 280, which demonstrates the stages and features involved in the destination module. In one form, procedure 280 is at least partially implemented in the operating logic of system 20. Procedure 280 begins at start point 282 with the system providing and the user reviewing information about reaching his goal (stage 284). The user is asked to fill out a survey and is provided with instructions on how to re-enroll in the program in the future to work on new goals. The user is congratulated on reaching their goal and invited to celebrate (stage 286). The user then meets with the field guide for a final progress meeting (stage 288). During the final meeting, if the field guide is satisfied with the information provided by the user, the user is provided with a reward related to a career. As one non-limiting example, upon completion of the destination module, the user can be provided with a Thermos® bottle with a compass and/or a carabineer, so as to help keep the user cool and pointed in the right direction. The process then ends at stage 290. In one embodiment, a follow-up email is sent periodically, such as annually, to request that the user provide feedback on how the career development system impacted the user's life. Additionally, the user can remain an active member on the systems message boards or other communication medium such as a chat room to provide assistance for subsequent users.

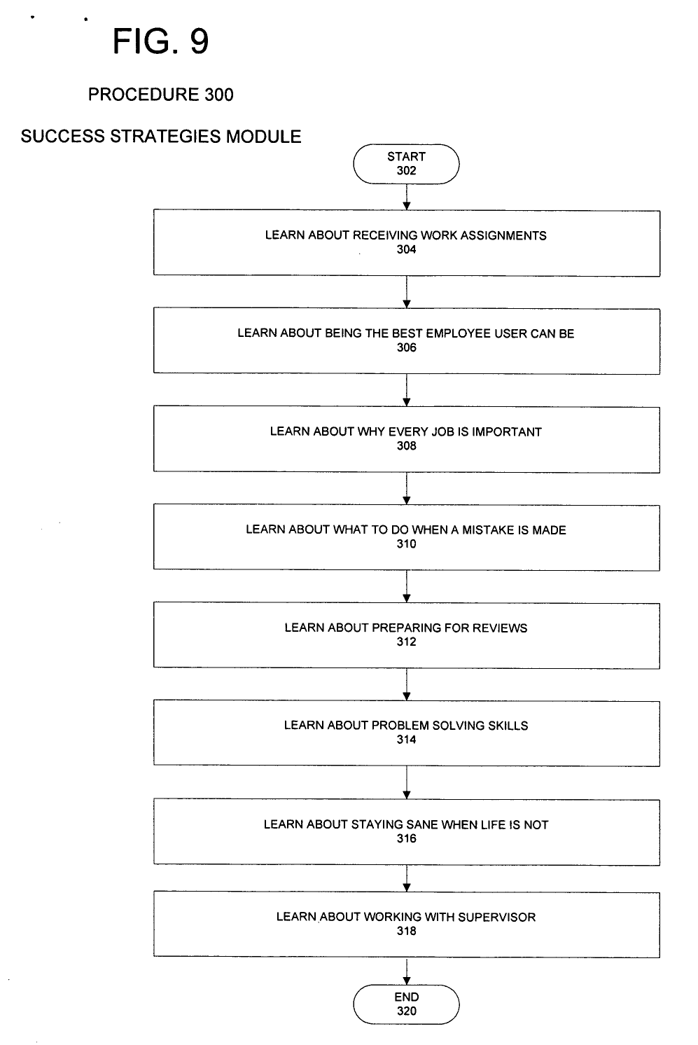

Turning now to FIG. 9, one embodiment for implementing system 20 with success strategies module 92 is illustrated in flow chart form as procedure 300, which demonstrates the stages and features involved in the success strategies module. In one form, procedure 300 is at least partially implemented in the operating logic of system 20. Procedure 300 begins at start point 302 with the system providing and the user reviewing information concerning one or more topics related to a better work life. The user can review information about work assignments (stage 304), being the best employee she can be (stage 306), why every job is important (stage 308), what to do when he makes a mistake (stage 310), and/or how to prepare for performance reviews (stage 312). Alternatively or additionally, the user can review information about problem solving skills (stage 314), how to stay sane when life is not (stage 316), and/or how to work with a supervisor (stage 318). These pieces of information can be reviewed in any order. Alternative or additional topics than these mentioned as non-limiting examples can also be provided. The process then ends at stage 320.

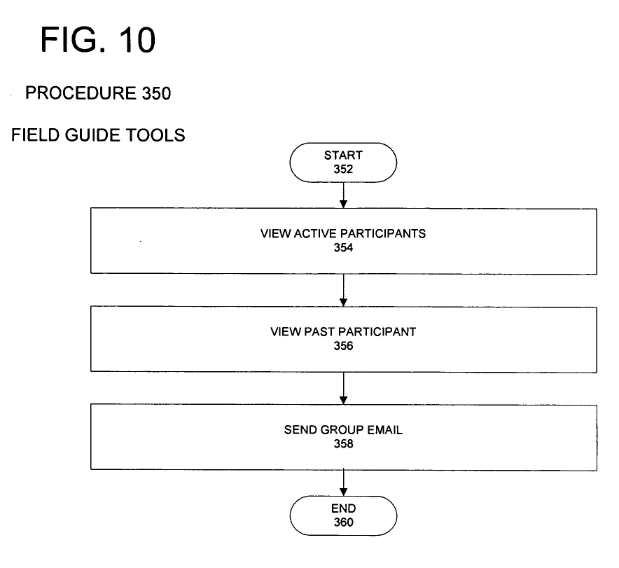

Turning now to FIG. 10, one embodiment for implementing system 20 with field guide admin tool 94 is illustrated in flow chart form as procedure 350, which demonstrates the stages and features involved in allowing a field guide to administer certain options on the site.

In one form, procedure 350 is at least partially implemented in the operating logic of system 20. Procedure 350 begins at start point 352 with the field guide selecting from one of multiple options. For example, the field guide can select an option to view and/or edit information about the active participants in the career development system (stage 354). The field guide can select an option to view information about the past participants in the career development system (stage 356). Details about the progress made in the different modules can be viewed for both current and past users, or updated for current users. For example, the field guide can enter notes about meetings with participants and mark the successful completion of a particular module. In one embodiment, certain fields cannot be edited once a particular event has happened, such as a module being closed, to name a non-limiting example. The field guide can select an option to send a group email to one or more selected current users of the career development system (stage 358). In one embodiment, there are varying levels of security assigned to field guides, such as field guides who can only view and edit information regarding the users they are working with, and supervisor field guides who can view information for any user, as well as access certain managerial features such as reports and sending group emails to all field guides. The process then ends at stage 360.

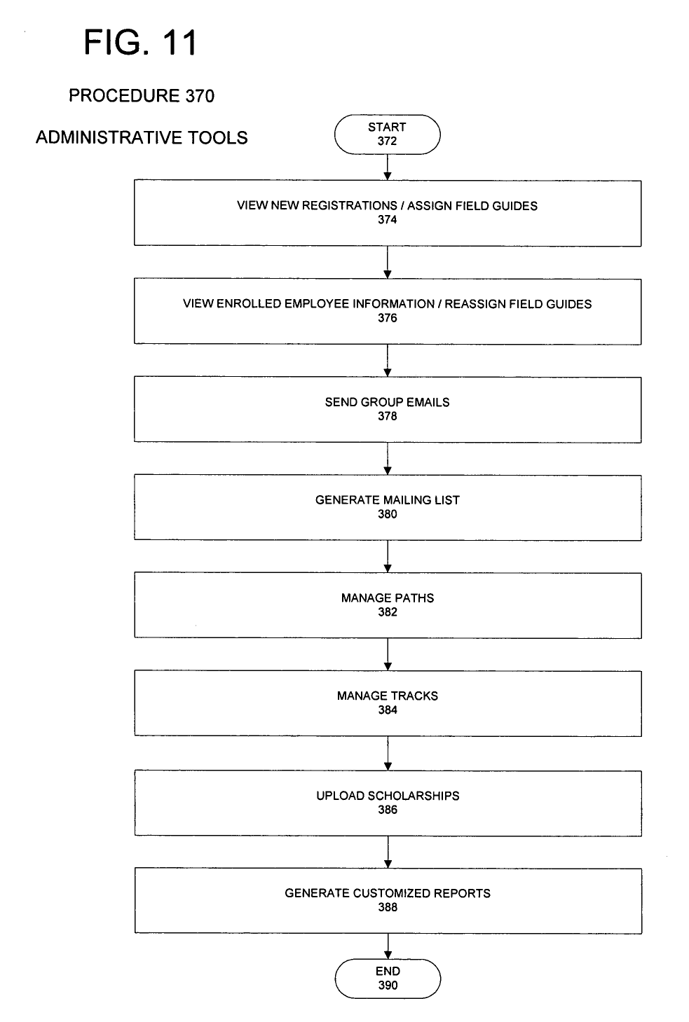

Turning now to FIG. 11, one embodiment for implementing system 20 with administrator tool 96 is illustrated in flow chart form as procedure 370, which demonstrates the stages and features involved in allowing an administrator to administer certain options on the site. In one form, procedure 370 is at least partially implemented in the operating logic of system 20. Procedure 370 begins at start point 372 with the administrator selecting one of various options. For example, the administrative user can select an option to view new registrations and/or assign a field guide (stage 374). The administrator can select an option to view enrolled employee information and/or reassign a field guide (stage 376). He can also select an option to send group emails to current participants in the career development system (stage 378). He can select an option to generate a mailing list (stage 380). The administrator can view and manage the paths that a user is allowed to select within the career development system (stage 382), as well as the career tracks that a user can select (stage 384). The administrator can also upload scholarship information (stage 386) and request customized reports (stage 388). The process then ends at stage 390.

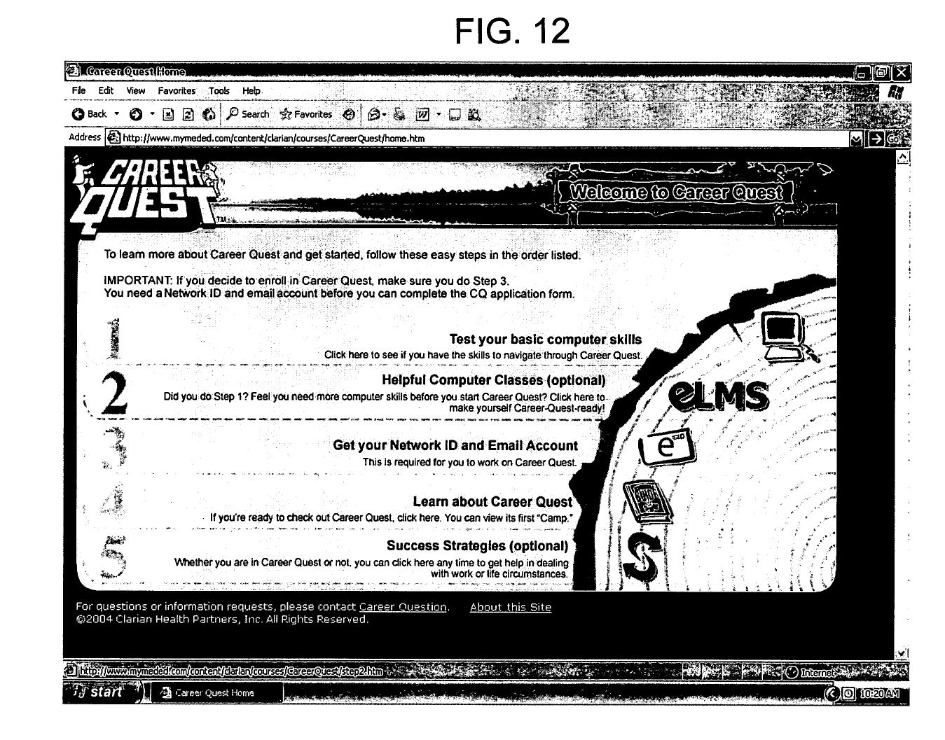

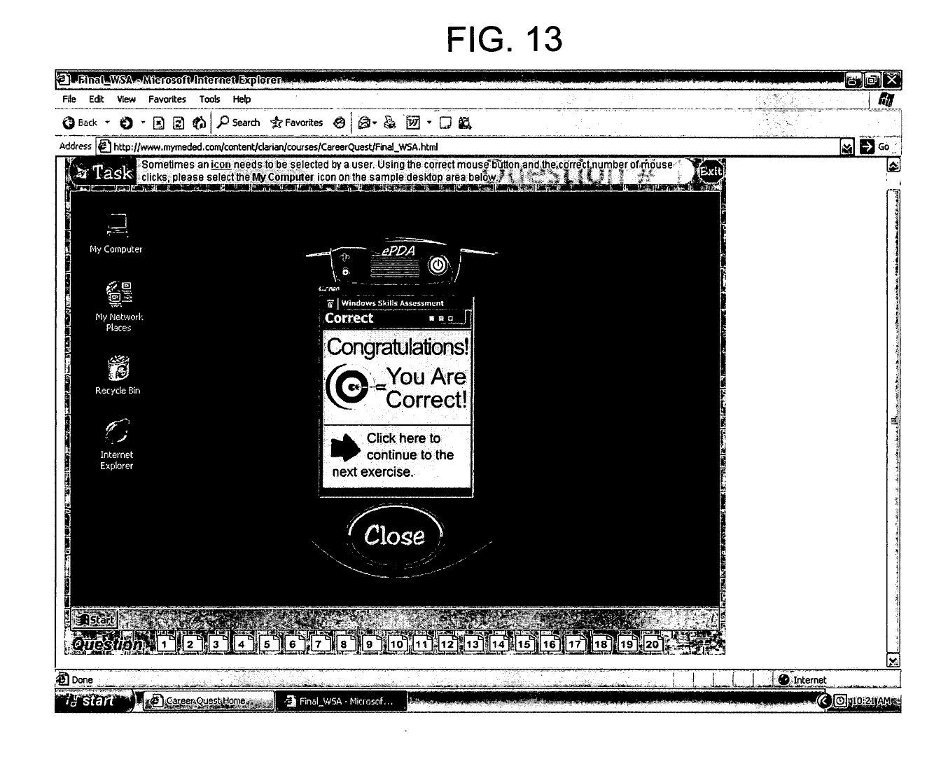

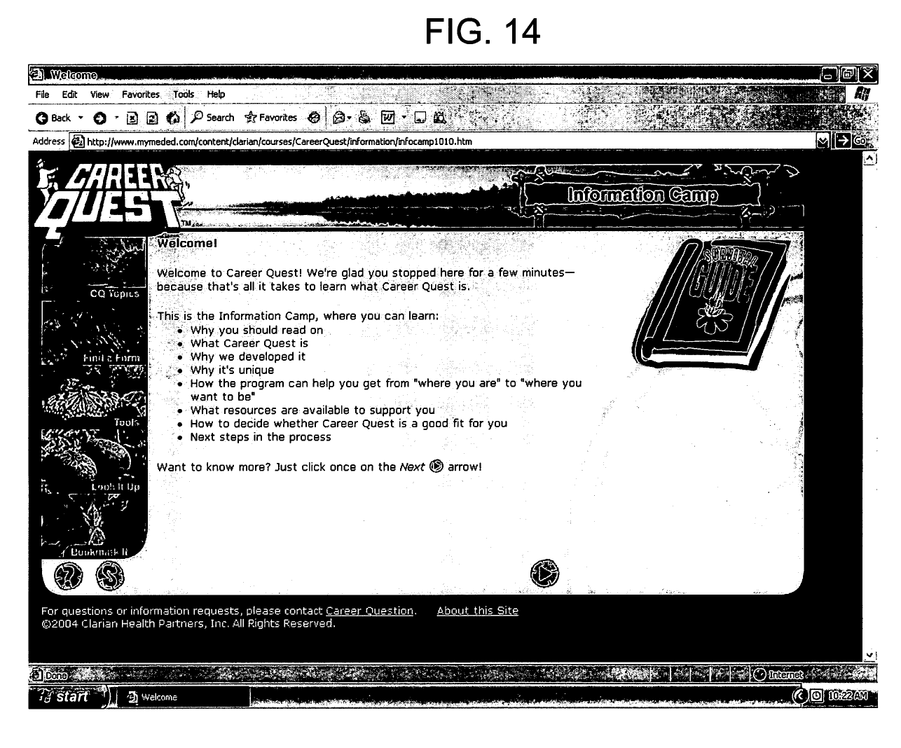

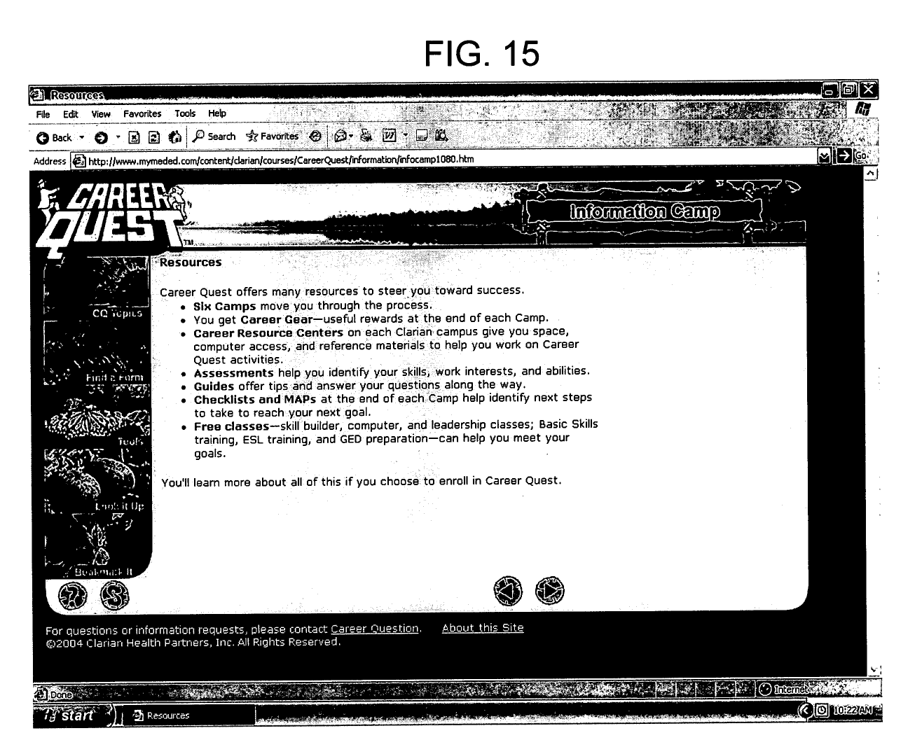

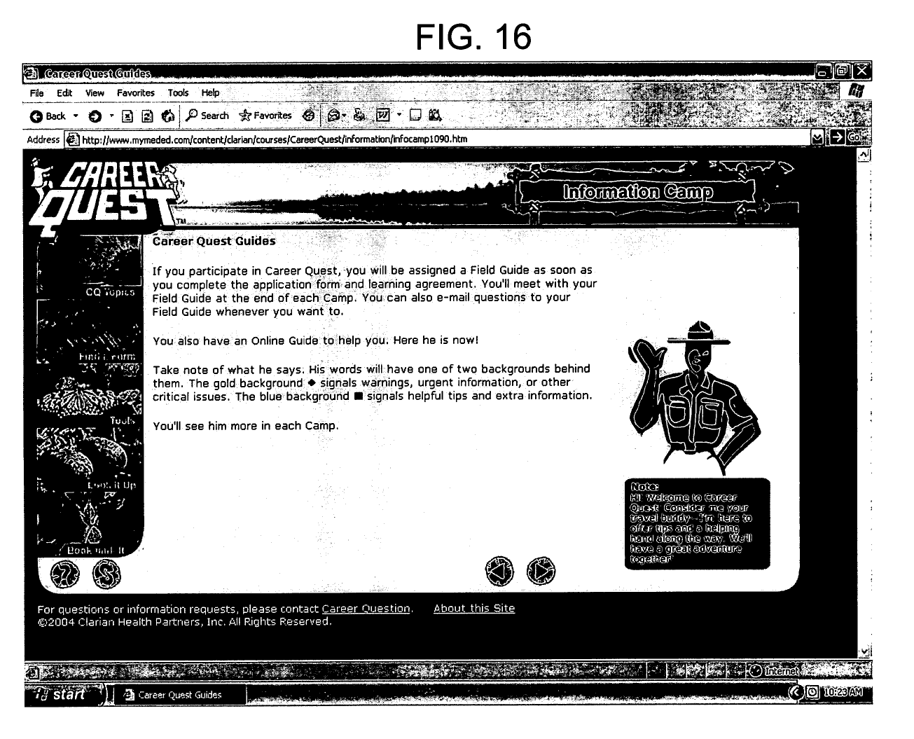

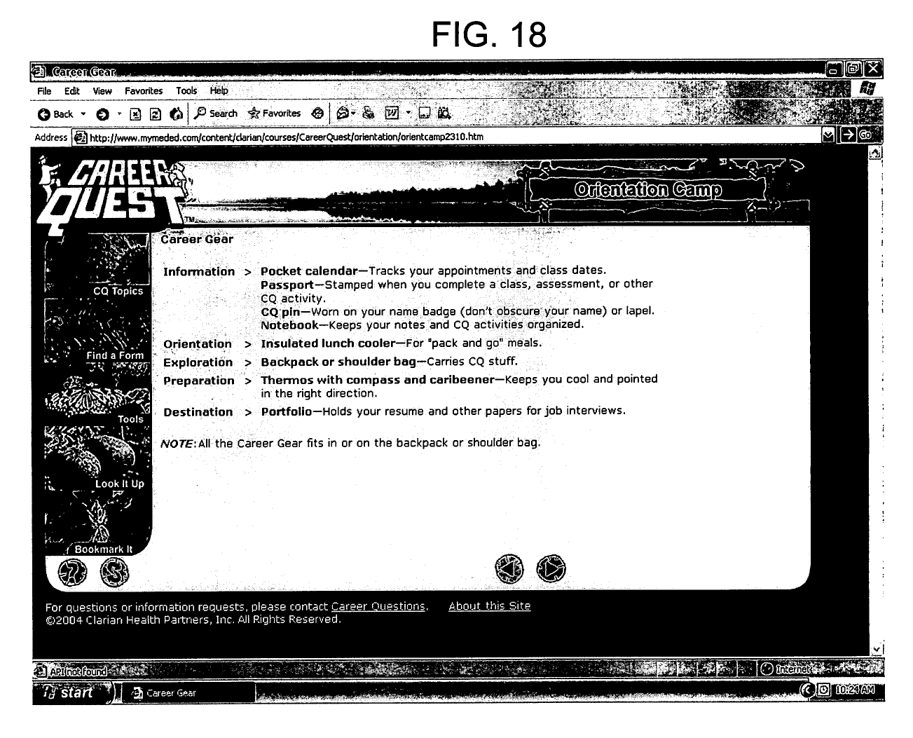

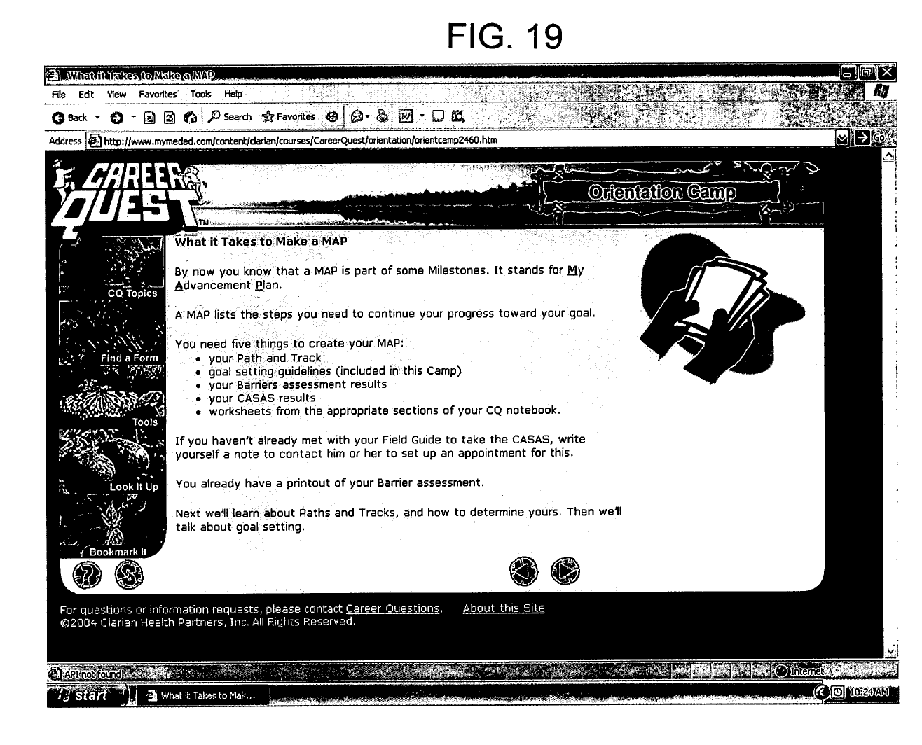

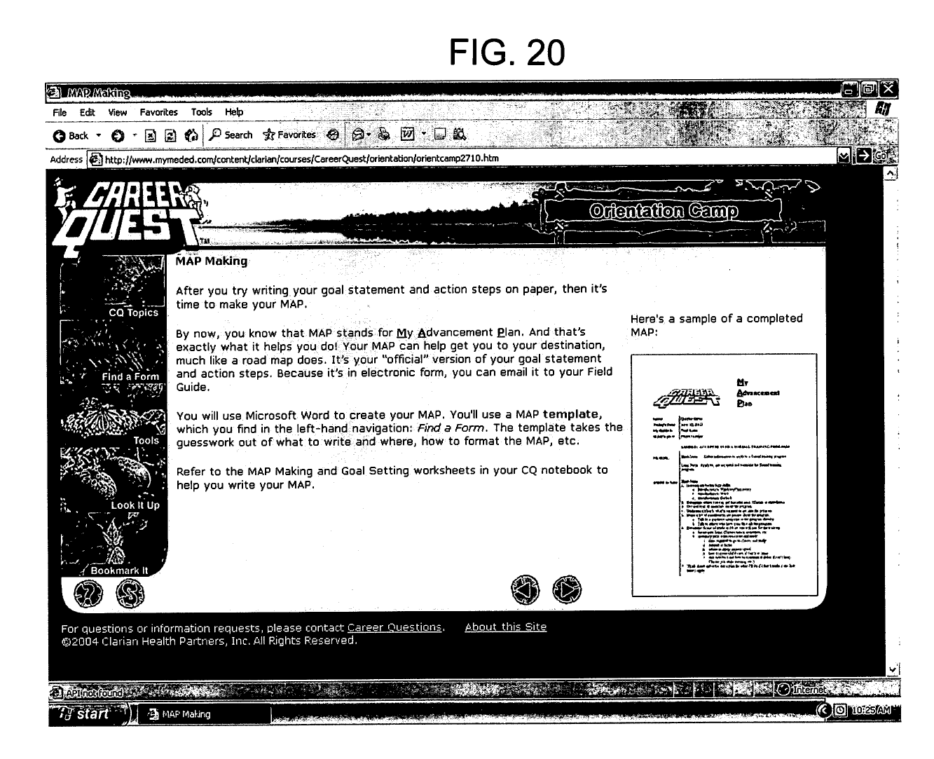

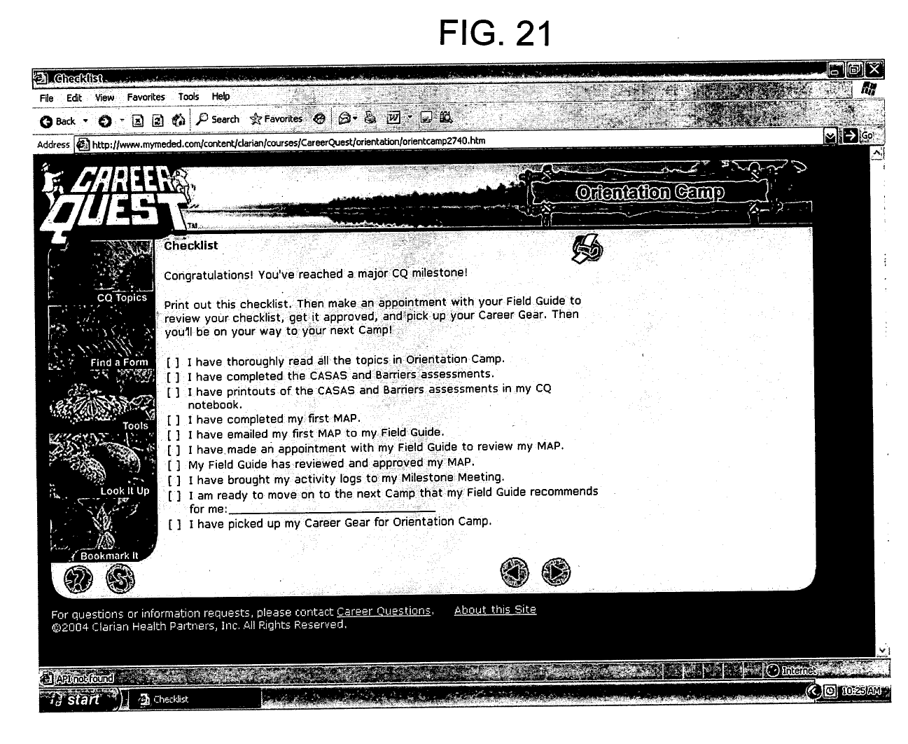

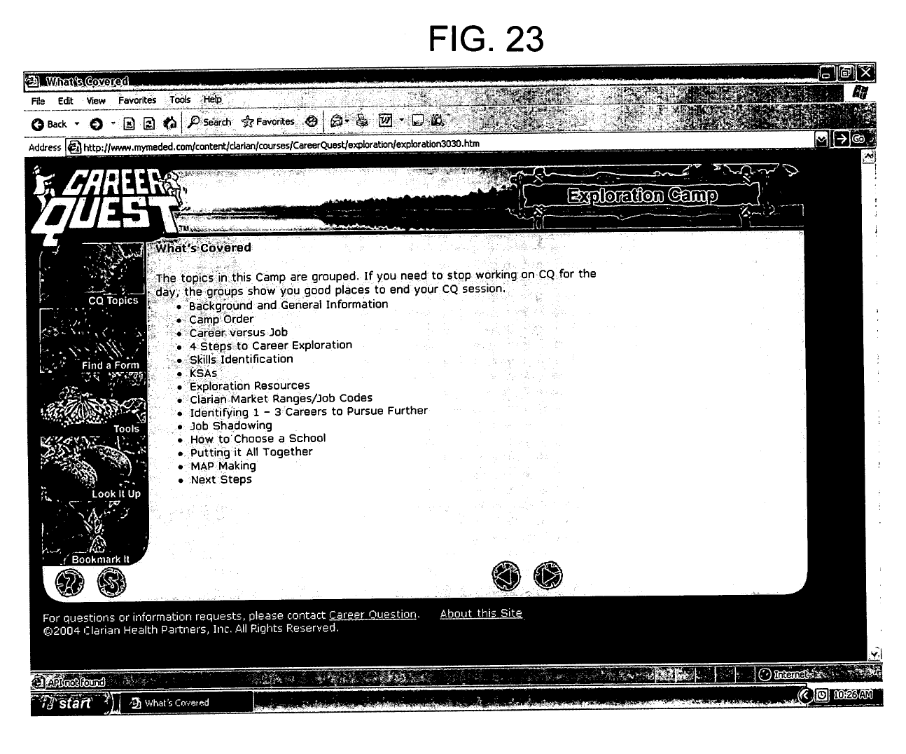

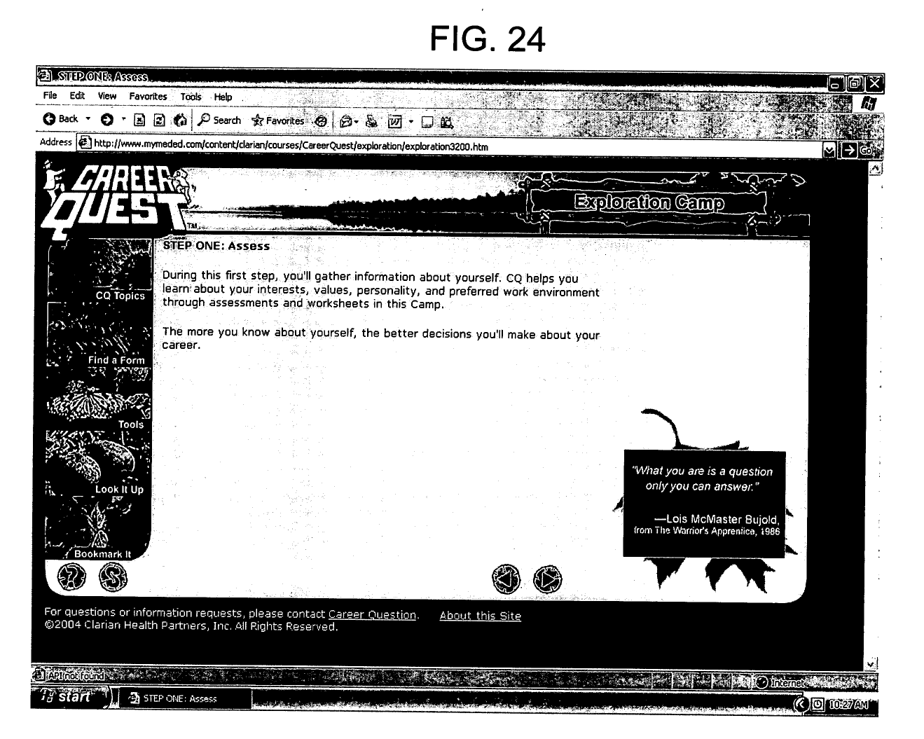

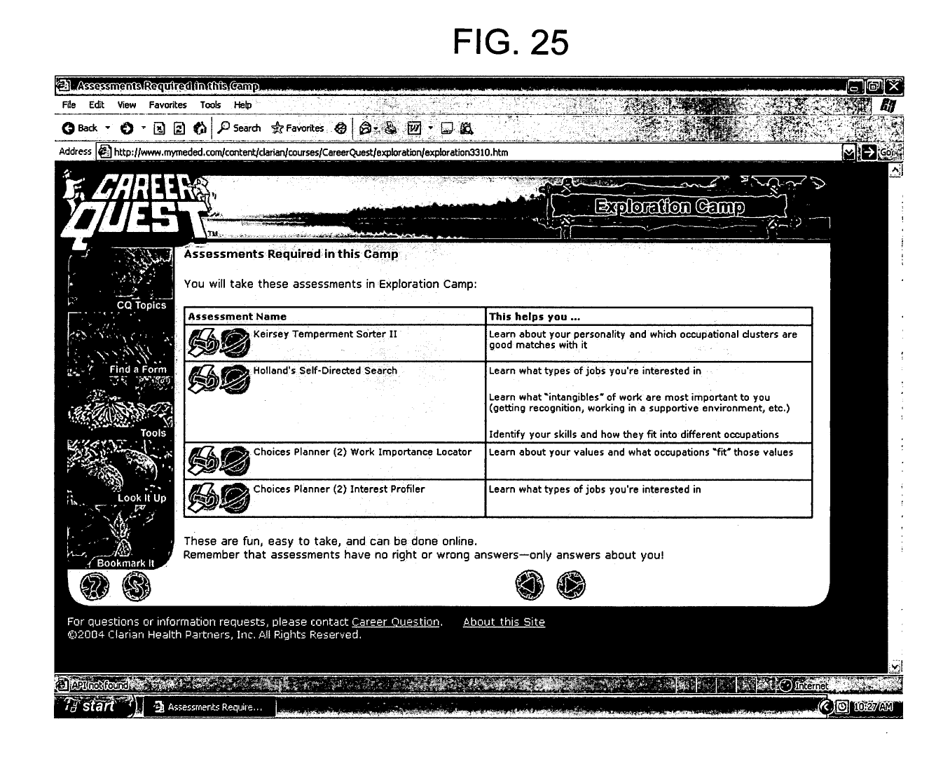

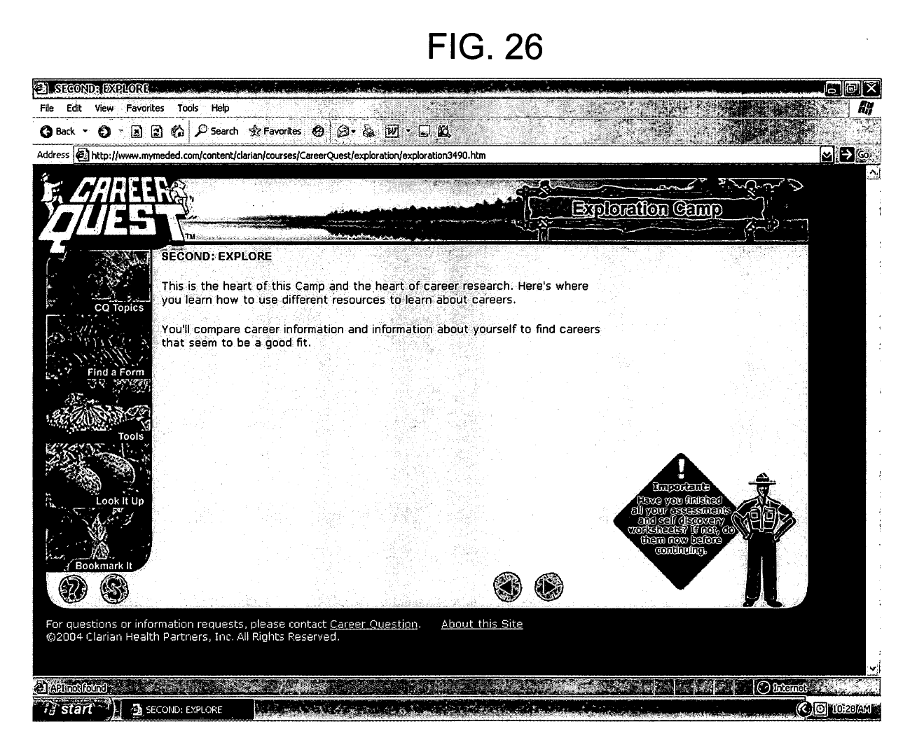

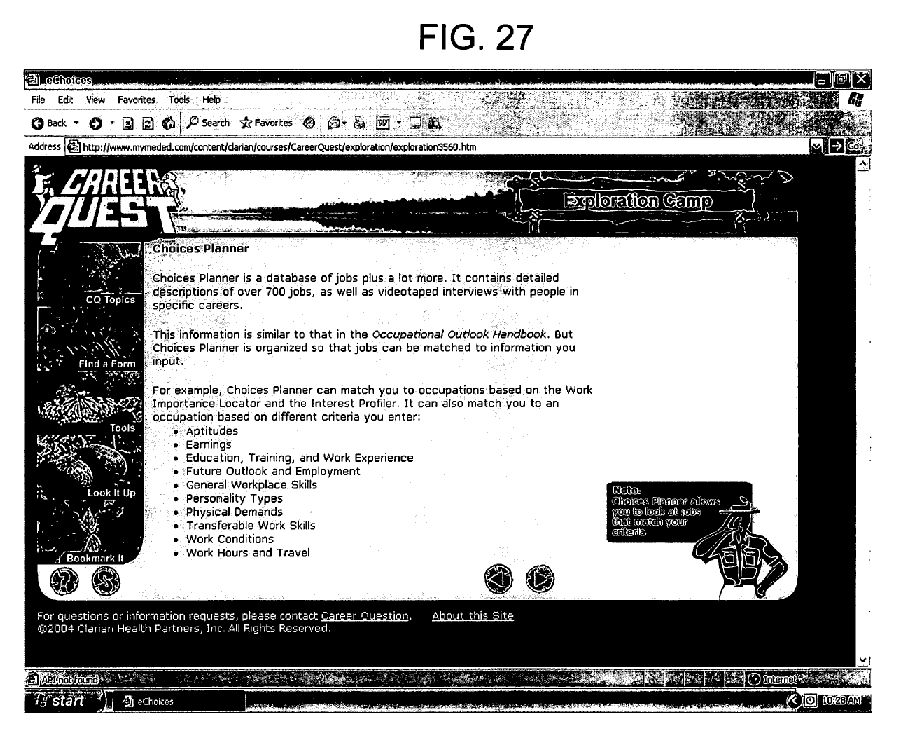

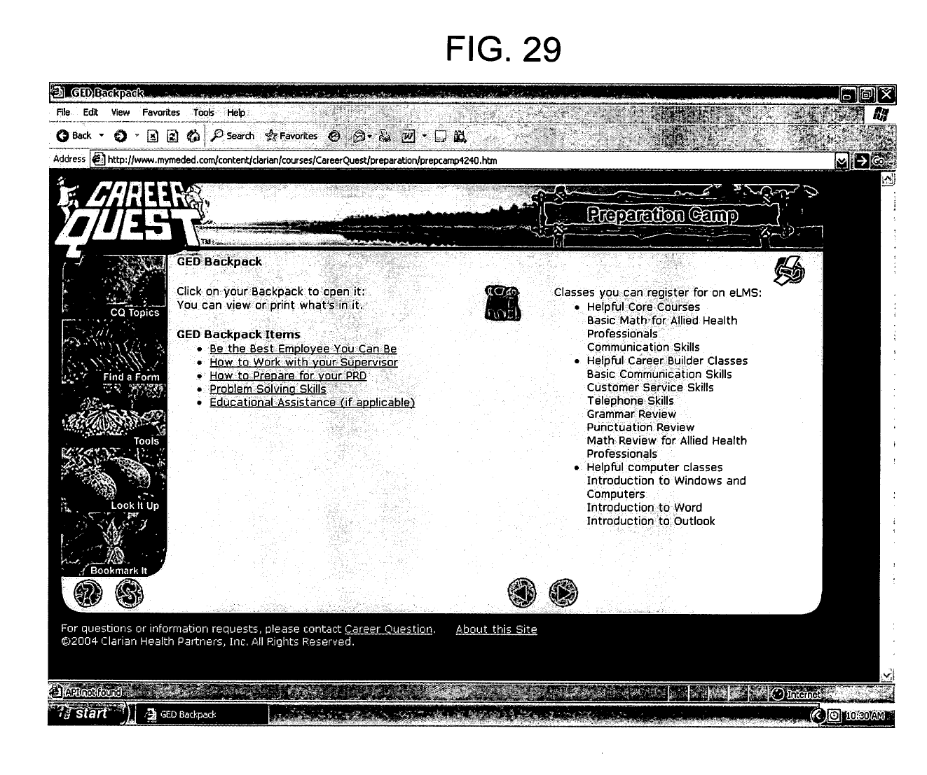

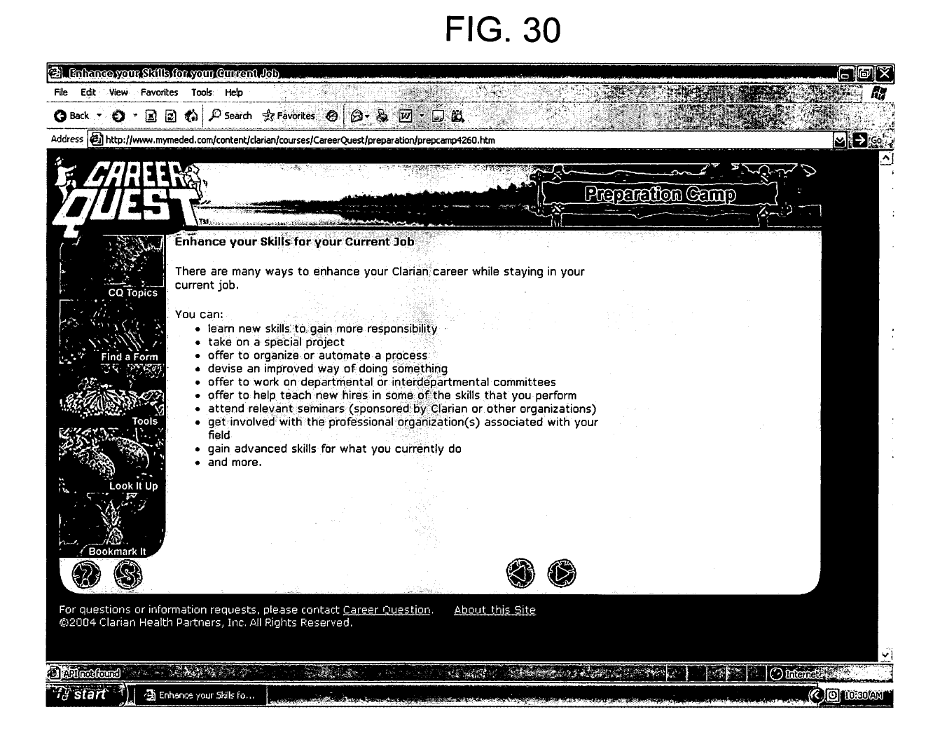

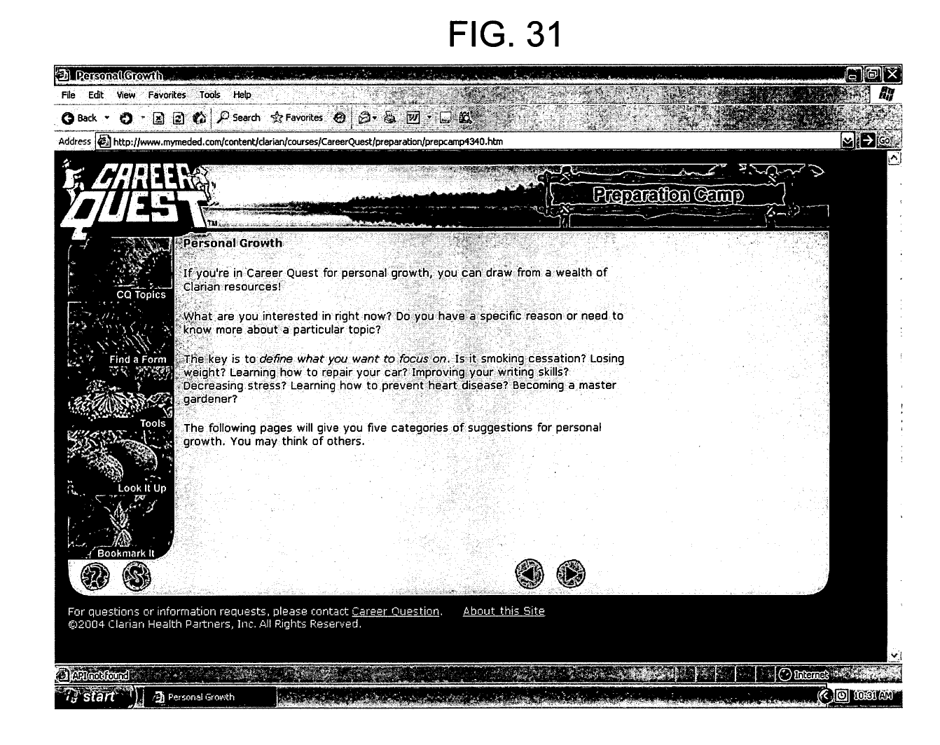

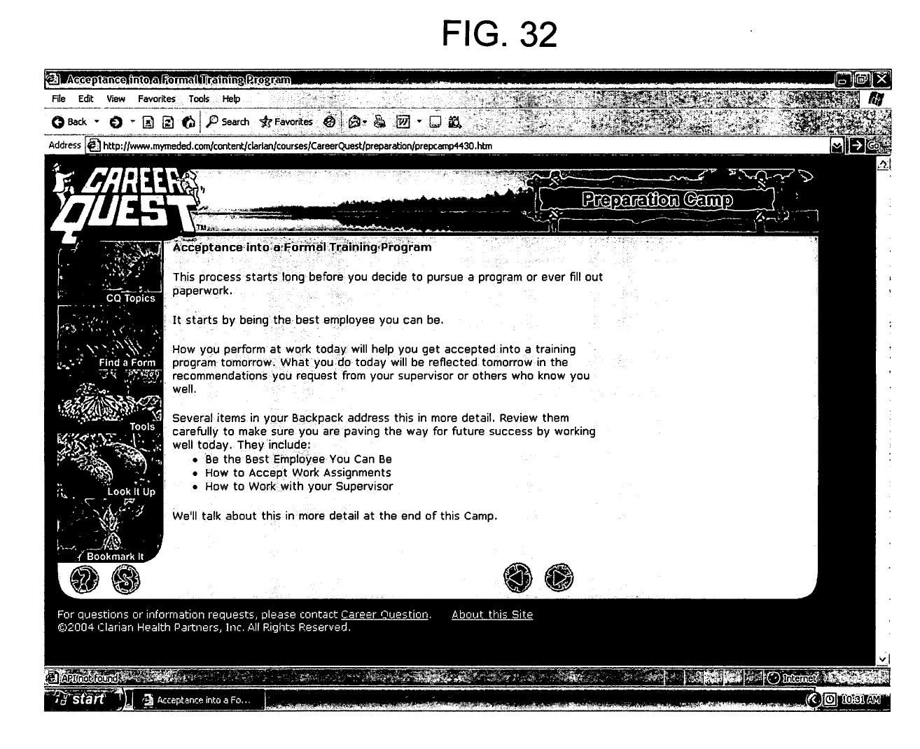

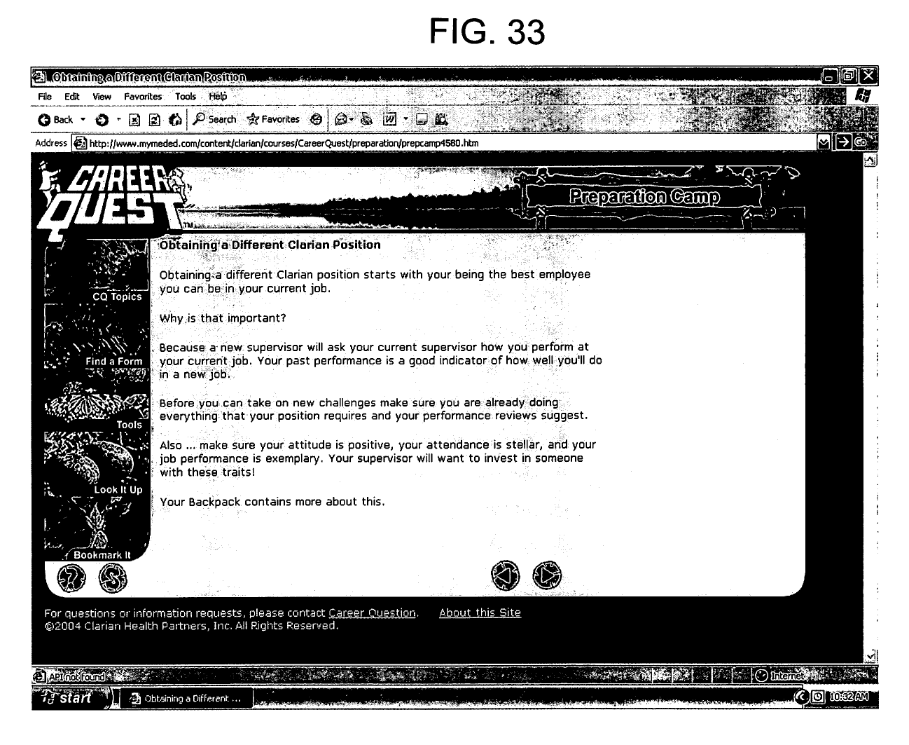

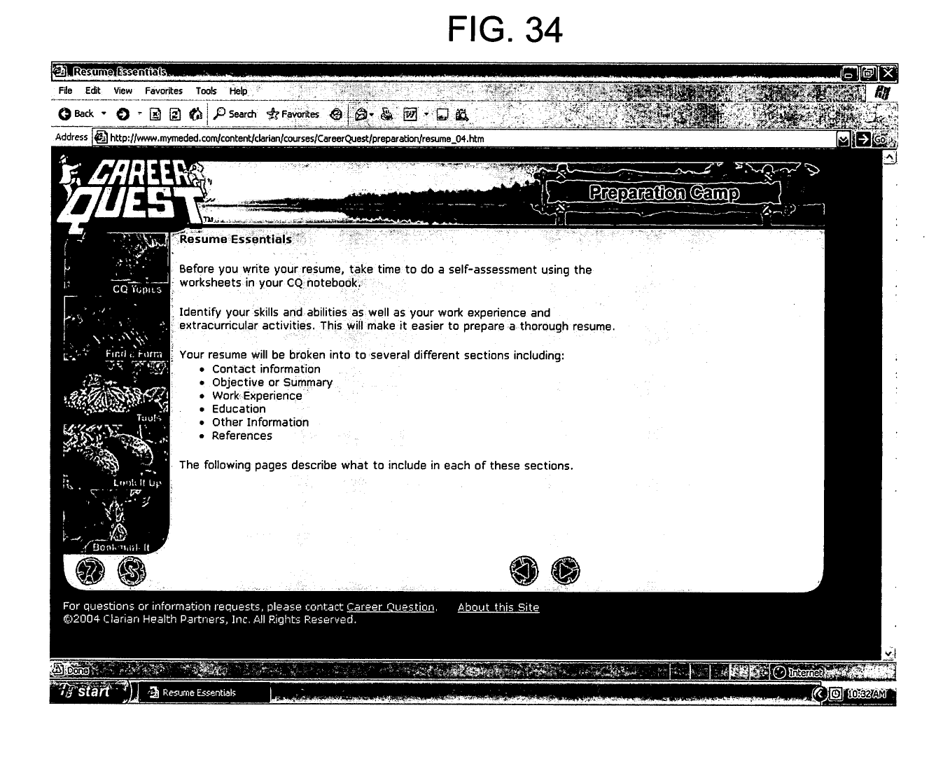

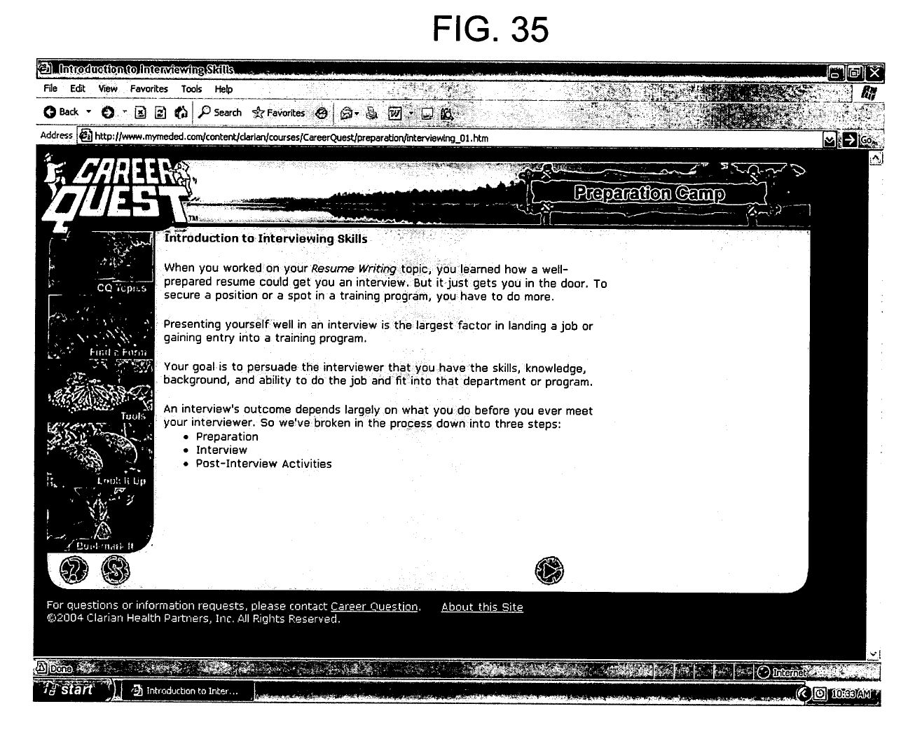

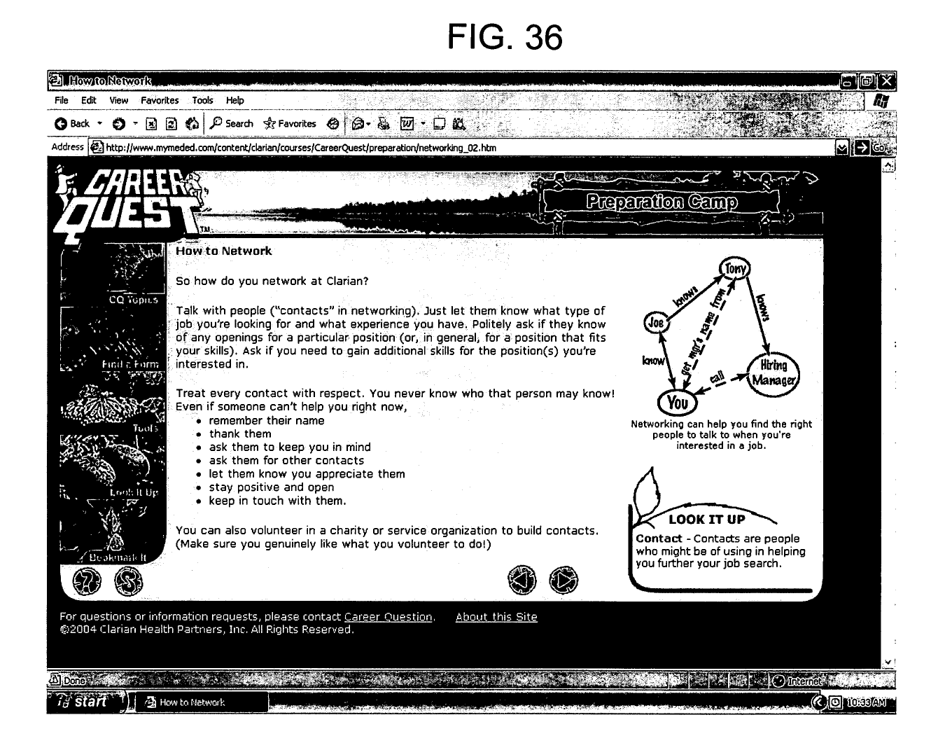

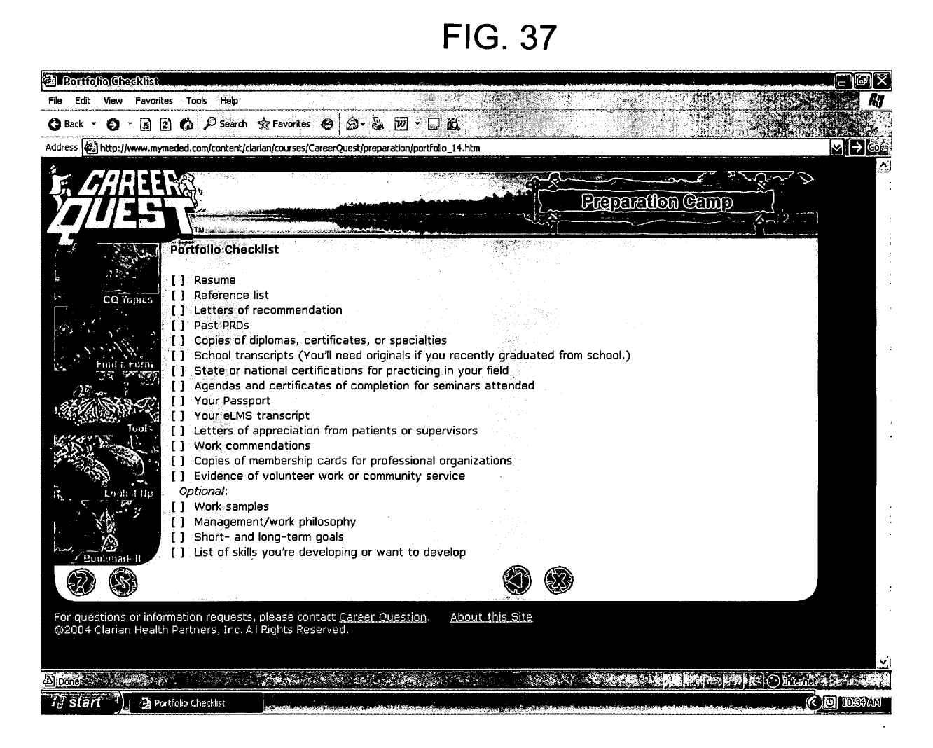

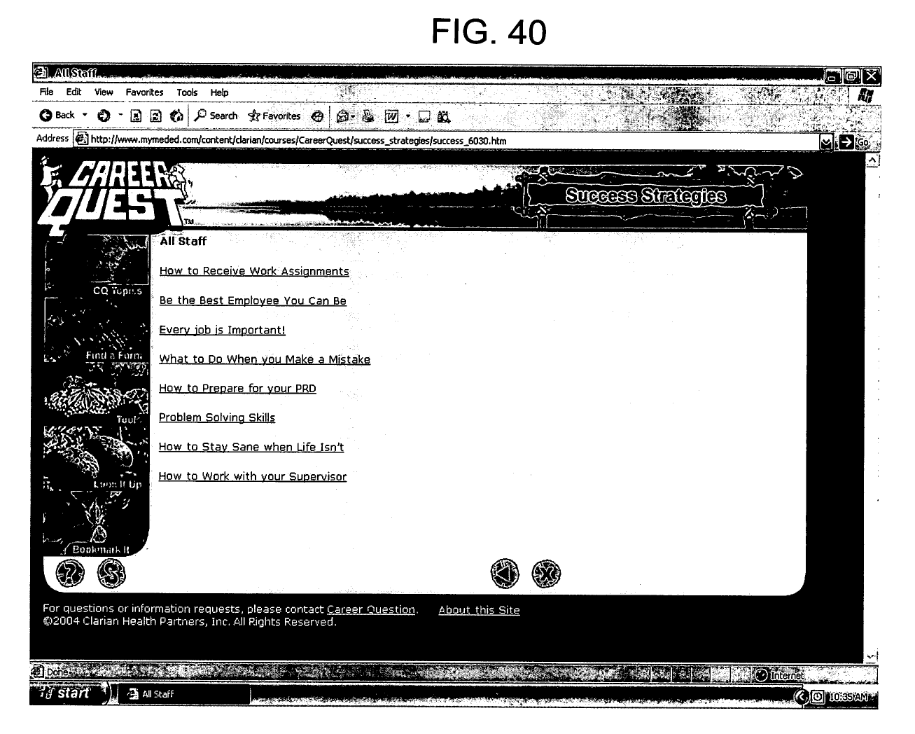

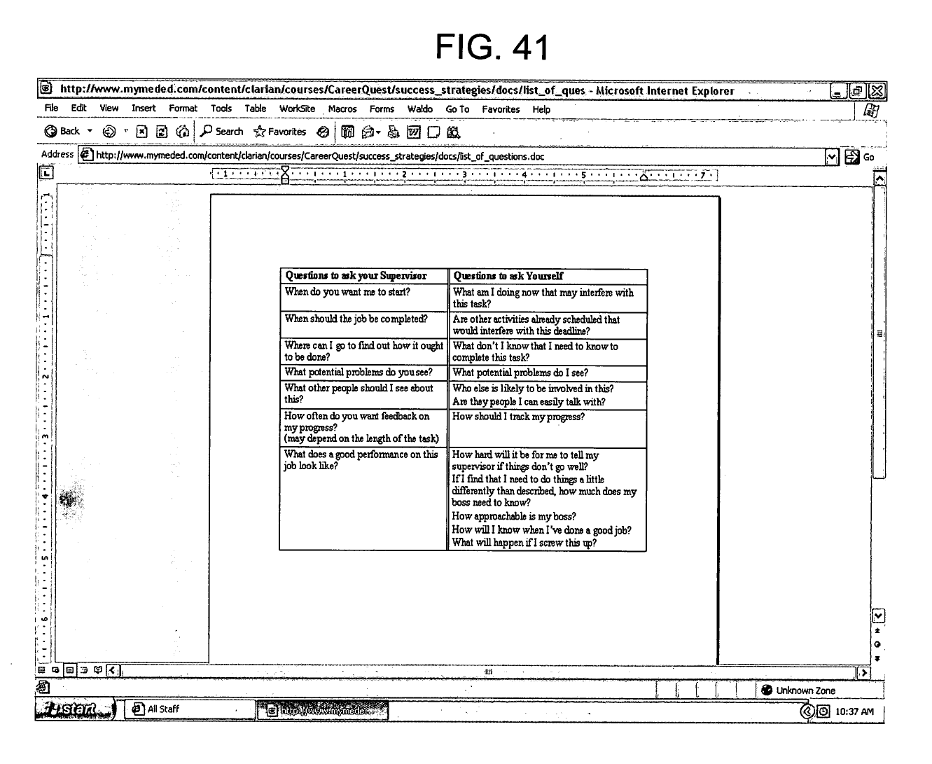

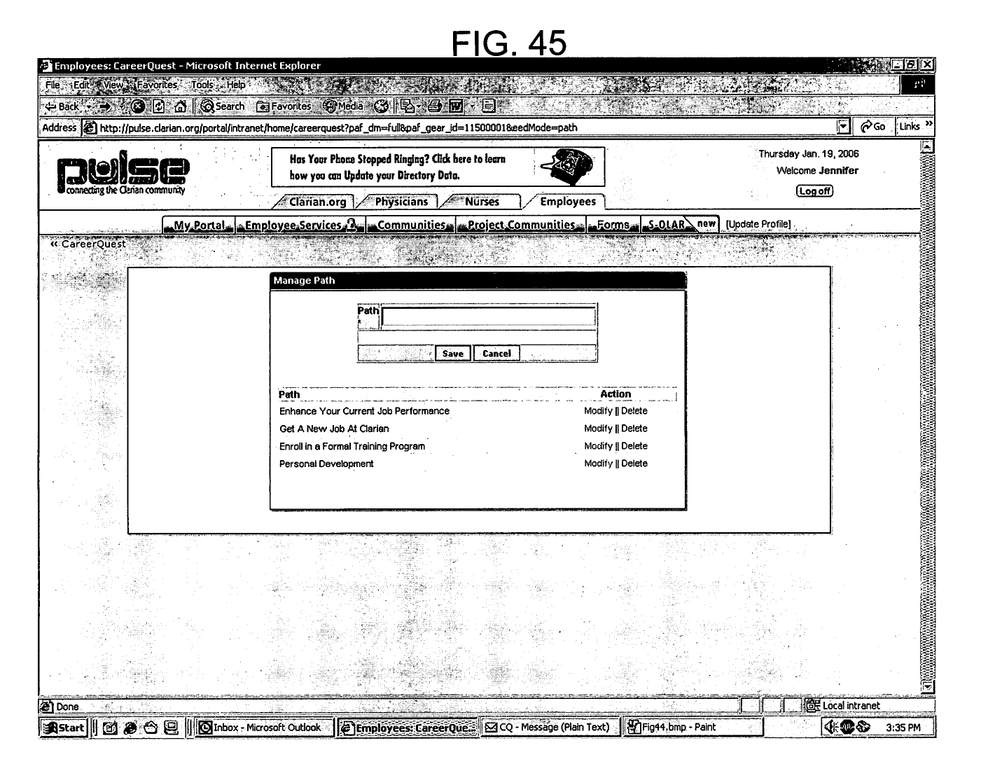

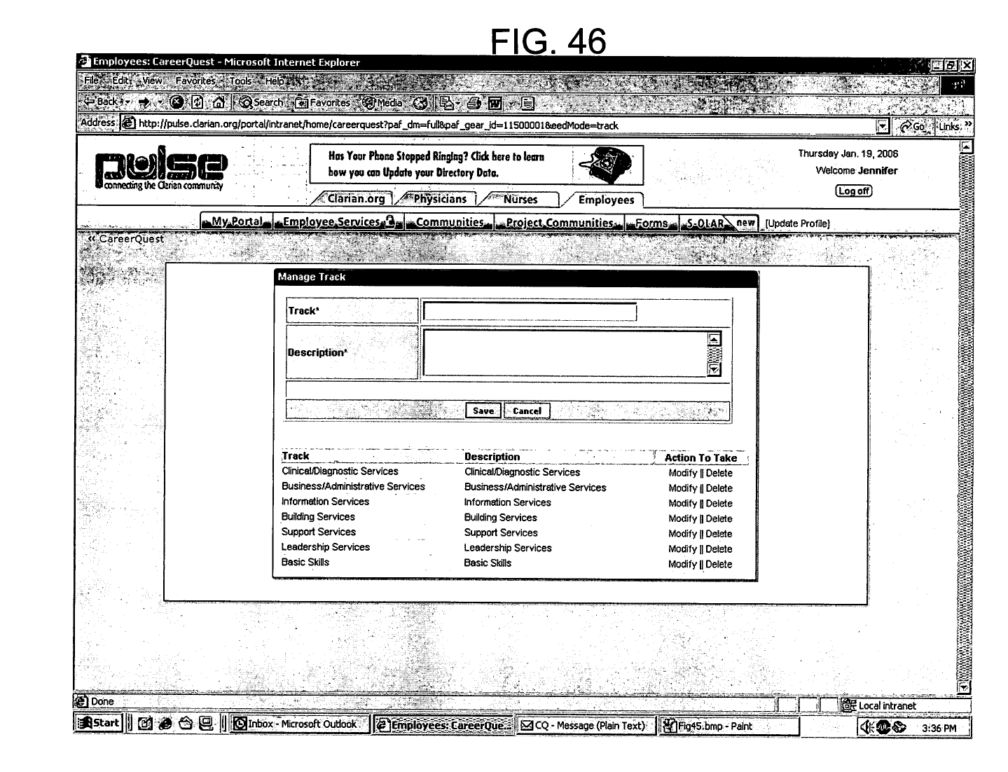

FIGS. 12-46 are simulated screens that illustrate one embodiment of at least part of the stages of FIGS. 3-11. For example, FIG. 12 is a simulated browser user interface screen illustrating an introduction screen to the career development system. FIG. 13 is a simulated browser user interface screen illustrating one example of a basic computer skills testing screen. FIGS. 14-16 are simulated browser user interface screens illustrating a sample of the information offered in the information module 82 in accordance with the stages of FIG. 4.

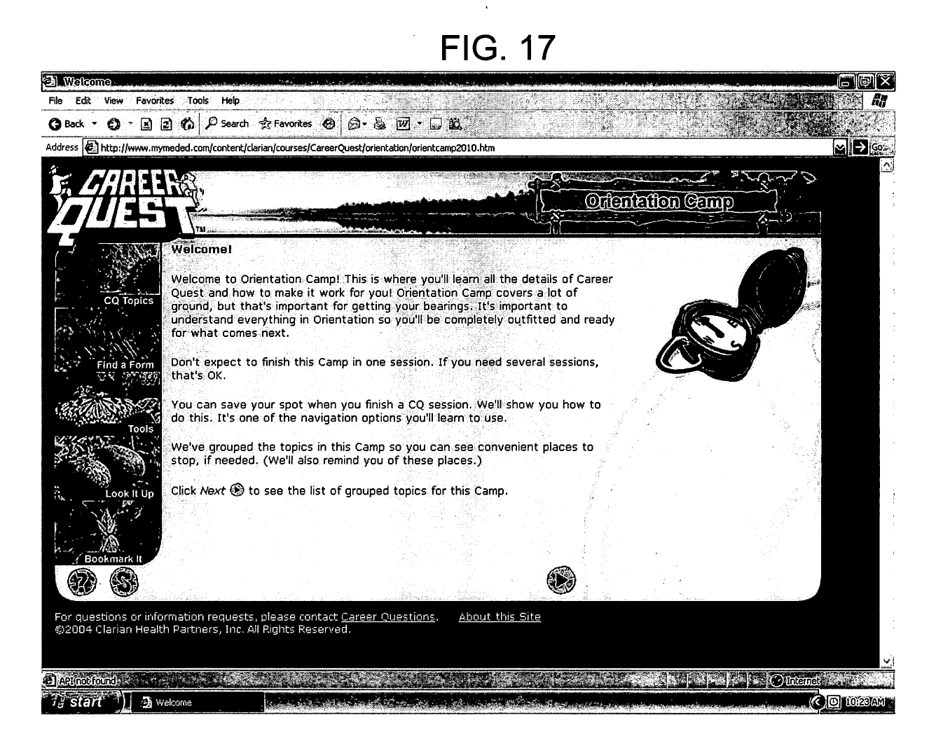

FIGS. 17-21 are simulated browser user interface screens illustrating a sample of the information offered in the orientation module 84 in accordance with the stages of FIG. 5.

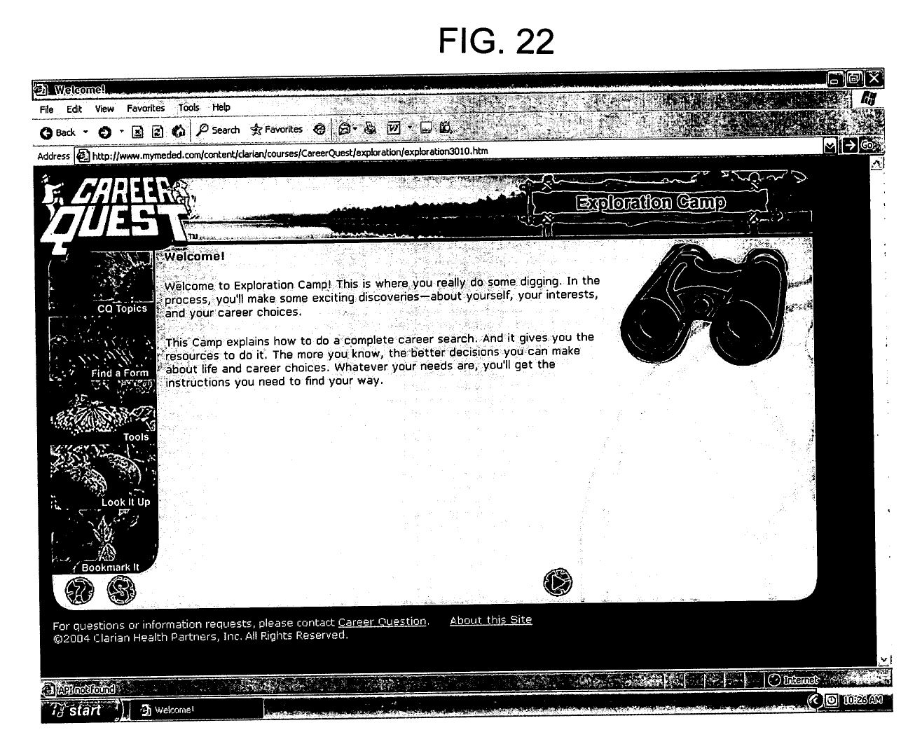

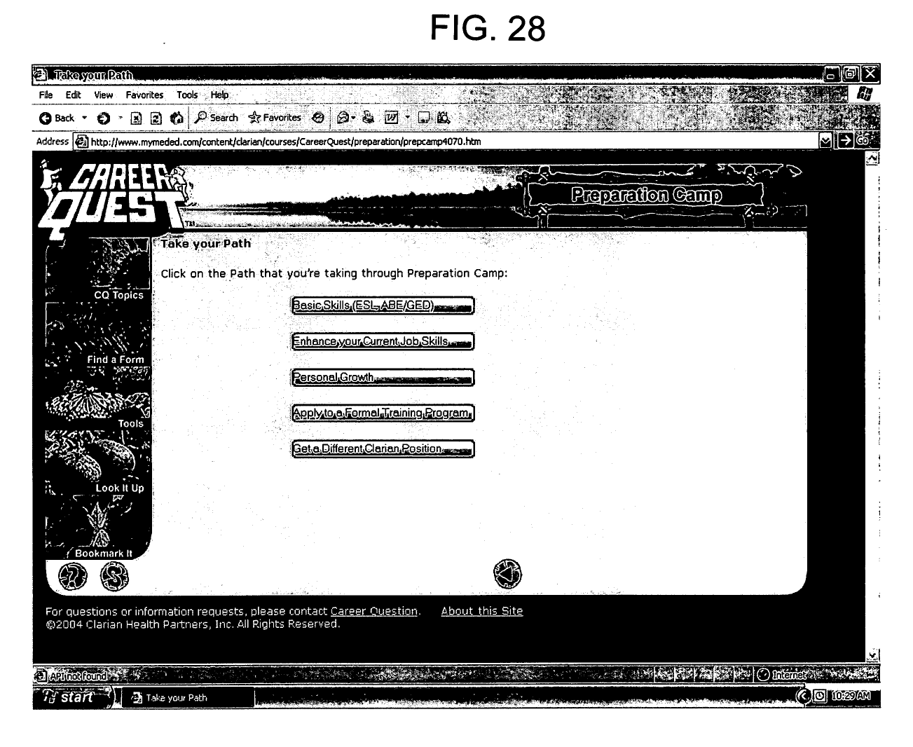

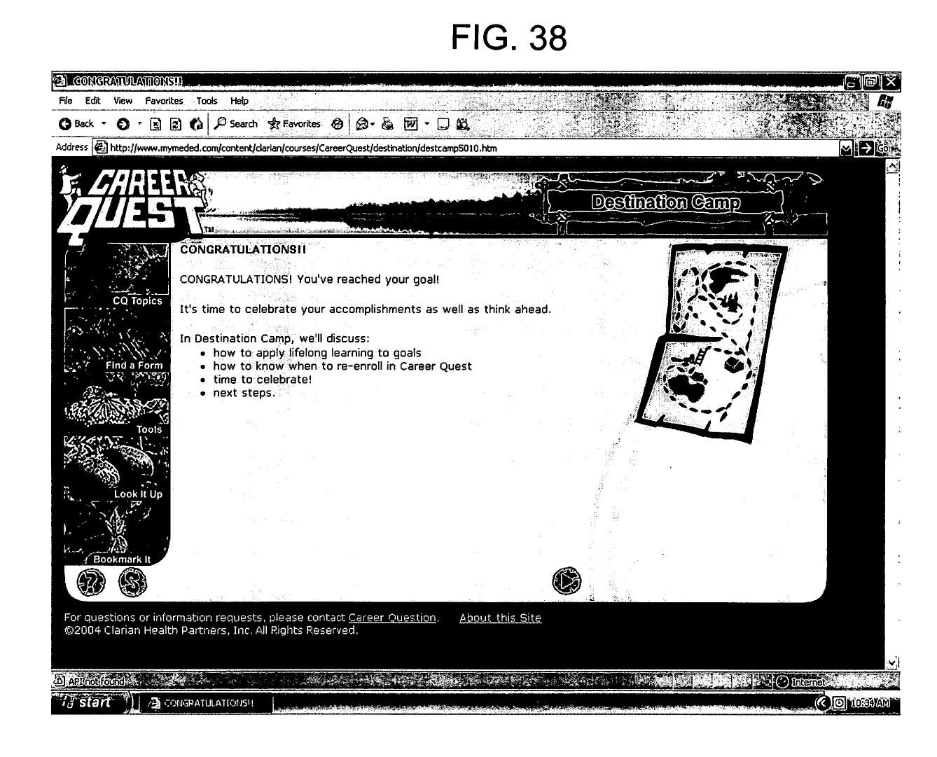

FIGS. 22-27 are simulated browser user interface screens illustrating a sample of the information offered in the exploration module 86 in accordance with the stages of FIG. 6. FIGS. 28-37 are simulated browser user interface screens illustrating a sample of the information offered in the preparation module 88 in accordance with the stages of FIG. 7. FIG. 38 is a simulated browser user interface screen illustrating a sample of the information offered in the destination module 90 in accordance with the stages of FIG. 8.

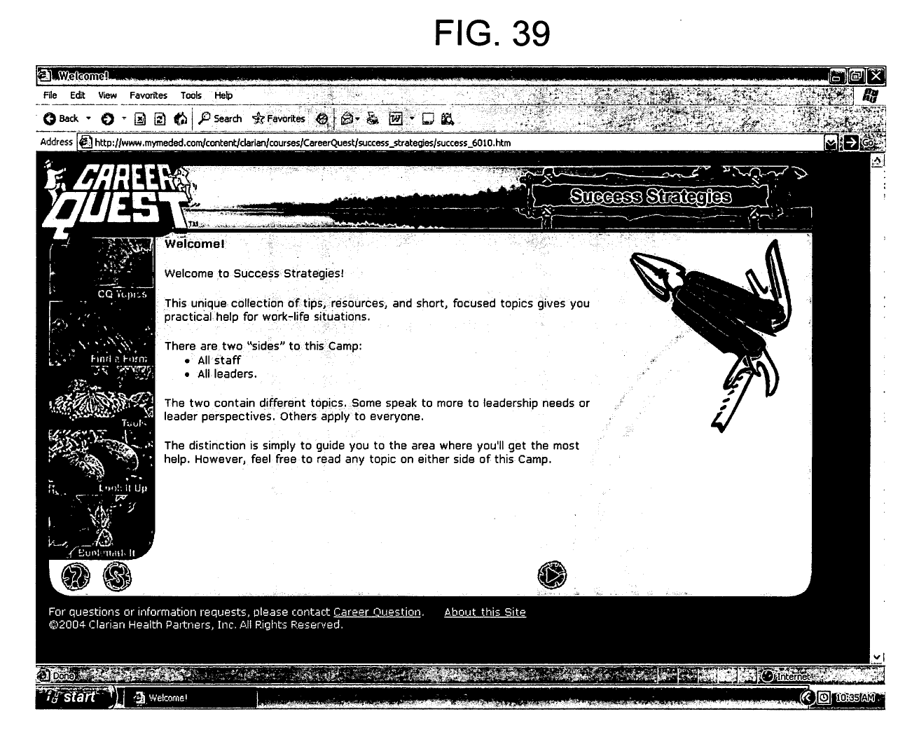

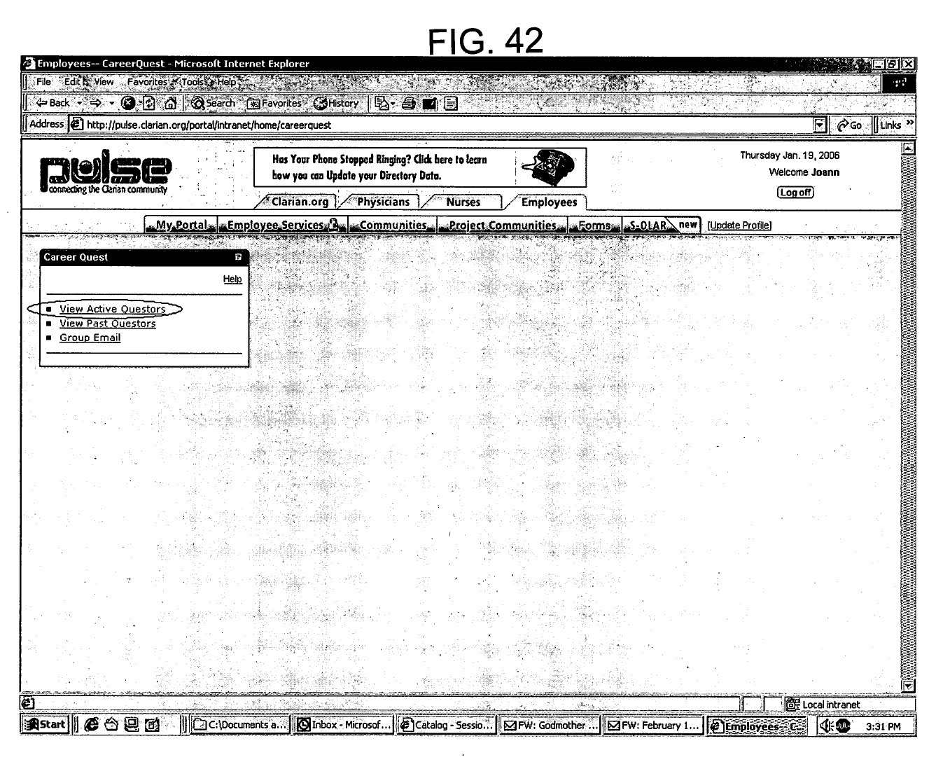

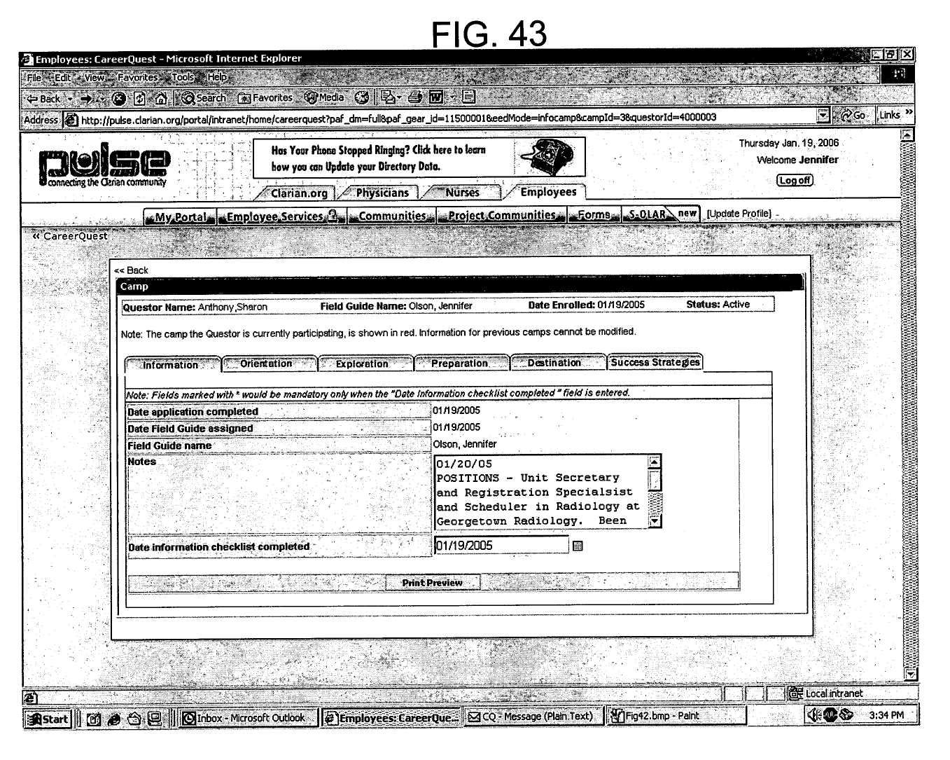

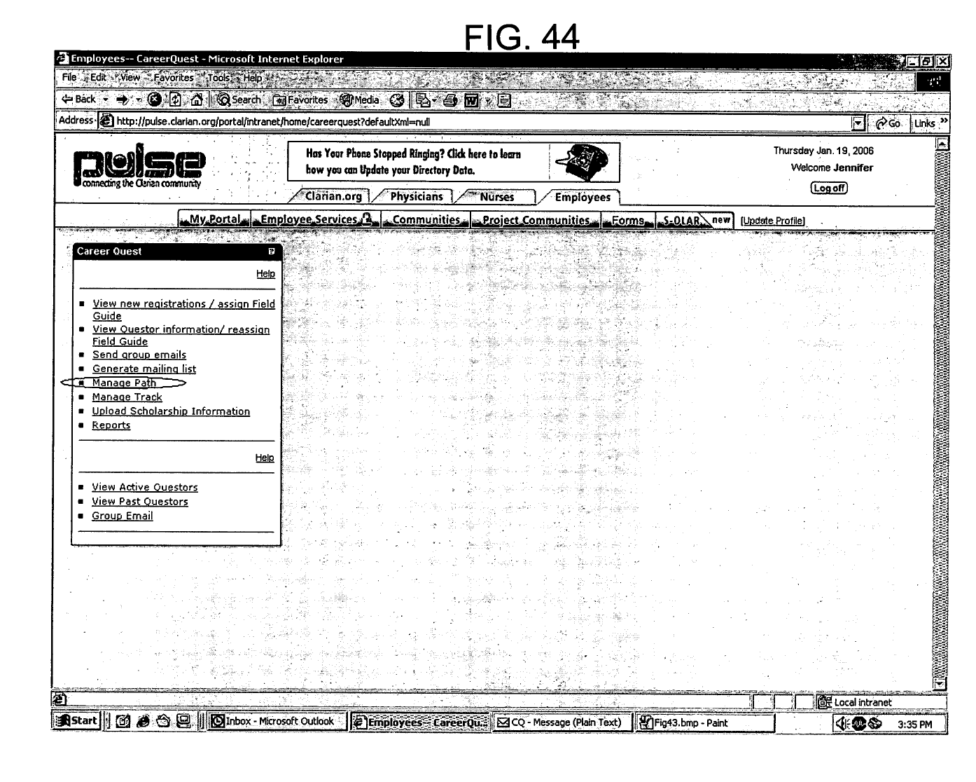

FIGS. 39-41 are simulated browser user interface screens illustrating a sample of the information offered in the success strategies module 92 in accordance with the stages of FIG. 9. FIGS. 42-43 are simulated browser user interface screens illustrating a sample of the features available to field guides in the field guide administrator tools 94 in accordance with the stages of FIG. 10. FIGS. 44-46 are simulated browser user interface screens illustrating a sample of the features available to administrators in the administrator tools 96 in accordance with the stages of FIG. 11.

Alternatively or additionally, one or more portions of system 20 are grouped together into one or more separate stand-alone courses based on subject or other related matters, so the information can be provided without requiring a user to complete one or more of the various sequential modules in the career development process. As a few non-limiting examples, content in one or more of the modules of system 20 can be offered as a stand-alone course to cover a topic such as resume writing, interviewing skills, preparing for performance reviews, and basic goal setting.

Alternatively or additionally, system 20 includes one or more electronic bulletin boards that contain questions that were posed by users who had a specific question about their career. In one embodiment, the user contacts a subject matter expert or other designated individual by email or another communication means and the question and answer is posted to an electronic bulletin board for other users to see. In another embodiment, the user posts a question directly to the bulletin board and is notified when an answer is posted to the bulletin board by a subject matter expert or other individual who answered the question. In another embodiment, the system 20 includes a chat room to supplement the message board and provide real time communication between the users.

Alternatively or additionally, system 20 provides career branching functionality that stores career progress information to help a user pursue one or more careers over a period of time. As one non-limiting example, a user who becomes a surgical technologist could later branch into a career as a nurse or a first assistant. As another non-limiting example, a radiographer could later become certified in ultrasound, MRIs, and so on, or get dual credentialing in radiation therapy.

Alternatively or additionally, system 20 has functionality in the exploration module or another module to allow users the opportunity to enroll in virtual or real job shadows after narrowing down their career choices to the finalists. For real job shadows, the field guide assigned to the user makes initial contact to the department and gets permission for the user to contact a specified person in the department. Then the user sets up a time and date with the department to perform the job shadow. Evaluations can be completed by the user and/or departmental contact after completion. With virtual job shadowing, the user watches a streaming video or a shadowing “experience” at his or her convenience. In one embodiment, the video is edited down so that the user sees the highlights of a typical day in less than an hour.

A person of ordinary skill in the computer software art will recognize that the client and/or server arrangements, user interface screen content, and data layouts could be organized differently to include fewer or additional options or features than as portrayed in the illustrations and still be within the spirit of the invention.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method for providing career development services utilizing an electronic network connected to a computer system and a memory device comprising the steps of:
establishing a plurality of modules containing career development information on said memory device having at least one module which guides a user through the process of developing a personalized plan for career advancement;
establishing a user database on said memory device having at least one data record representing said user of said system and storing the progress of said user through said plurality of modules;
assigning a counselor to said user; and
displaying to said user at least one of said plurality of modules over a communications network in response to an indication of acceptance received from said counselor.

2. The method of claim 1 wherein at least one module in said plurality of modules is presented to the user as a series of one or more web-pages.

3. The method of claim 1 wherein at least one module in said plurality of modules directs said user to outside resources for additional information.

4. The method of claim 1 wherein at least one module in said plurality of modules contains information to assist said user in selecting a prospective career.

5. The method of claim 4 wherein at least one module in said plurality of modules contains information for improving the personal assessment skills of said user.

6. The method of claim 1 further comprising the step of providing a tangible reward to said user in response to the completion of one of said plurality of modules.

7. The method of claim 6 wherein said reward is an item related to career advancement.

8. The method of claim 1 wherein said data record includes contact information for said user.

9. The method of claim 8 wherein said data record includes an e-mail address associated with said user.

10. The method of claim 1 wherein said plan for career advancement is a checklist of goals for obtaining a new job within a company.

11. The method of claim 1 wherein said plan for career advancement is a checklist of goals for enrolling in a training program.

12. The method of claim 1 wherein said plan for career advancement is a checklist of goals for obtaining professional development.

13. The method of claim 1 wherein said plan for career advancement is a checklist of goals for enhancing skills for a current job.

14. The method of claim 10 wherein the user is an employee of said company.

15. The method of claim 10 wherein the counselor is an employee of said company.

16. The method of claim 1 further comprising the step of assessing the computer skills of said user and suggesting training resources as needed.

17. The method of claim 1 further comprising the step of assessing the literary skills of said user and suggesting training resources as needed.

18. The method of claim 1 further comprising the step of receiving a question from said user pertaining to a career field and directing said question to a person of knowledge in said career field.

19. The method of claim 18 wherein said question is sent to said person of knowledge via email.

20. The method of claim 18 wherein said question is posted to an electronic bulletin board.

21. The method of claim 20 wherein said bulletin board is accessible to all users associated with the system.

22. The method of claim 20 wherein said user is notified when a response to said question is available.

23. The method of claim 1 further comprising the step of providing for said user information on arranging job shadowing in response to an indication of interest in a particular career field.

24. The method of claim 23 wherein said information on arranging job shadowing is the contact information for a person working in said career field.

25. The method of claim 1 further comprising the step of providing to said user at least one job specific video showing the typical duties of a person working in said job.

26. The method of claim 25 wherein said video is streamed to the user over said communications network.

27. The method of claim 1 wherein said communications network is a wide area network.

28. The method of claim 1 wherein said communications network is the Internet.

29. A computer readable medium encoded with machine-readable instructions for causing a computer to implement the method comprising:
establishing a plurality of modules containing career development information on said memory device having at least one module which guides a user through the process of developing a personalized plan for career advancement;
establishing a user database on said memory device having at least one data record representing said user of said system and storing the progress of said user through said plurality of modules;
assigning a counselor to said user; and
displaying to said user at least one of said plurality of modules over a communications network in response to an indication of acceptance received from said counselor.

30. The computer readable medium of claim 29 wherein at least one module in said plurality of modules is presented to the user as a series of one or more web-pages.

31. The computer readable medium of claim 29 wherein at least one module in said plurality of modules directs said user to outside resources for additional information.

32. The computer readable medium of claim 29 wherein at least one module in said plurality of modules contains information to assist said user in selecting a prospective career.

33. The computer readable medium of claim 32 wherein at least one module in said plurality of modules contains information for improving the personal assessment skills of said user.

34. The computer readable medium of claim 29 wherein the method further comprises the step of providing a tangible reward to said user in response to the completion of one of said plurality of modules.

35. The computer readable medium of claim 34 wherein said reward is an item related to career advancement.

36. The computer readable medium of claim 29 wherein said data record includes contact information for said user.

37. The computer readable medium of claim 36 wherein said data record includes an e-mail address associated with said user.

38. The computer readable medium of claim 29 wherein said plan for career advancement is a checklist of goals for obtaining a new job within a company.

39. The computer readable medium of claim 29 wherein said plan for career advancement is a checklist of goals for enrolling in a training program.

40. The computer readable medium of claim 29 wherein said plan for career advancement is a checklist of goals for obtaining professional development.

41. The computer readable medium of claim 29 wherein said plan for career advancement is a checklist of goals for enhancing skills for a current job.

42. The computer readable medium of claim 38 wherein the user is an employee of said company.

43. The computer readable medium of claim 29 wherein the counselor is an employee of said company.

44. The computer readable medium of claim 29 wherein the method further comprises the step of assessing the computer skills of said user and suggesting training resources as needed.

45. The computer readable medium of claim 29 wherein the method further comprises the step of assessing the literary skills of said user and suggesting training resources as needed.

46. The computer readable medium of claim 29 wherein the method further comprises the step of receiving a question from said user pertaining to a career field and directing said question to a person of knowledge in said career field.

47. The computer readable medium of claim 29 wherein said question is sent to said person of knowledge via email.

48. The computer readable medium of claim 29 wherein said question is posted to an electronic bulletin board.

49. The computer readable medium of claim 48 wherein said bulletin board is accessible to all users associated with the system.

50. The computer readable medium of claim 48 wherein said user is notified when a response to said question is available.

51. The computer readable medium of claim 29 wherein the method further comprises the step of providing for said user information on arranging job shadowing in response to an indication of interest in a particular career field

52. The computer readable medium of claim 51 wherein said information on arranging job shadowing is the contact information for a person working in said career field.

53. The computer readable medium of claim 29 wherein the method further comprises the step of providing to said user at least one job specific video showing the typical duties of a person working in said job.

54. The computer readable medium of claim 53 wherein said video is streamed to the user over said network.

55. The computer readable medium of claim 29 wherein said communications network is a wide area network.

56. The computer readable medium of claim 29 wherein said communications network is the Internet.

57. A system for providing career planning services over an electronic network comprising:
a business enterprise including:
a user client system;
a counselor client system;
a data storage device comprising:
a user database; and
a module database;
a web server; and
a communications network;
wherein said user client system, said counselor client system, said data storage device, and said server are in communication with each other via said communications network; and wherein further, a career planning services solution for providing career planning information to a user on said user client system and allowing a counselor on said counselor client system to manage the progress of said user through a series of modules stored in said module database is executing on said web server.

58. The system of claim 57 wherein at least one of said series of modules is presented to the user as a series of one or more web-pages on said user client system.

59. The system of claim 57 wherein at least one of said series of modules directs said user to outside resources for additional information.

60. The system of claim 57 wherein at least one of said series of modules contains information to assist said user in selecting a career track.

61. The system of claim 60 wherein at least one of said series of modules contains information for improving the personal assessment skills of said user.

62. The system of claim 60 wherein said data storage device further comprises a message board database storing at least one message sent from said user client system containing a question relating to career fields.

63. The system of claim 60 further comprising an administrator client system providing advanced features to a select group of users.

64. The system of claim 63 wherein said advanced features include the ability to generate a mailing list of all users.

65. The system of claim 63 wherein said advanced features include the ability to assign a counselor to a user.

66. The system of claim 63 wherein said advanced features include the ability to manage the career paths a user is allowed to select.

67. The system of claim 63 wherein said advanced features include the ability to reassign a new counselor to a user.
